(19) United States
(12) Patent Application Publication
(10) Pub. No.: US 2020/0269130 A1
(43) Pub. Date: Aug. 27, 2020

(54) Reconfigurable Controller Devices, Systems, and Methods

(71) Applicant: TACTICAL HAPTICS, INC., Union City, CA (US)

(72) Inventors: William R. Provancher, Fremont, CA (US); Daniel J. Lee, Fremont, CA (US)

(21) Appl. No.: 16/651,311

(22) PCT Filed: Sep. 25, 2018
(86) PCT No.: PCT/US18/52750

§ 371 Date: Mar. 26, 2020

Related U.S. Application Data
(60) Provisional application No. 62/564,096, filed on Sep. 27, 2017.

(51) Int. Cl. A63F 13/24; A63F 13/98; A63F 13/211; A63F 13/235; G06F 3/01

(52) U.S. Cl. CPC A63F 13/24; A63F 13/98; A63F 13/211; A63F 2300/1043; G06F 3/014; G06F 3/016; A63F 13/235

(57) ABSTRACT

The present invention relates to mating a controller to “mate-points” or objects in the environment, mating to accessories, or to mating multiple controllers together in different configurations by joining them at one of several possible mating locations that are part of the controllers. Changing the device configurations transforms both the way that input from the controllers is interpreted and how feedback is sent back to the controller. The mating interfaces between the controllers can be tailored to prevent or allow relative motion as per desired for a specific use case and to accommodate human ergonomics.

### CROSS- REFERENCE TO RELATED APPLICATIONS

This application claims priority to and the benefit of U.S. Provisional Application Ser. No. 62/564,096 entitled “RECONFIGURABLE CONTROLLER DEVICES, SYSTEMS, AND METHODS”, filed on Sep. 27, 2017, the entire content of which is incorporated by reference herein in its entirety.

### BACKGROUND OF THE DISCLOSURE

### 1. The Field of the Invention

Generally, this disclosure relates to controllers used with teleoperation, virtual reality (VR), augmented reality (AR), toy, gaming, or other systems. More specifically, the present disclosure relates to mating a controller to “mate-points” or objects in the environment, mating to accessories, or mating multiple controllers together in different configurations by joining them at one of several possible mating locations that are part of the controllers, wherein mating in one of several possible configurations can be used to transform both: (1) the way that input from the controllers is interpreted in each respective use case (e.g., mating the controllers in a machine gun configuration could make a machine gun appear onscreen in a video game), and (2) how feedback is sent back to the controller (e.g., audio or haptic feedback sent to the controller from a video game). The mating interfaces between the controllers can be tailored to prevent or allow relative motion as desired for a specific use case and to accommodate human ergonomics.

### 2. Background and Relevant Art

A powerful enhancement when interacting with teleoperated, virtual, toy, or gaming interfaces is to allow the user to more closely mimic the configuration (e.g., relative hand position) of the activity the user is remotely or virtually controlling, or mimic the configuration of the activity the user is pretending to do (i.e. in the case of children playing with toys). Typically, toys, video games, and telerobots have been controlled with a bi-manual game pad. Embodiments of the present approach utilize multiple attachment points on the controller that can be reconfigured and mated by the user either at the beginning of an interaction session or on-the-fly during the session. This creates the ability for the user to experience enhanced interaction in multiple configurations with the same controller without the need to purchase additional accessories. Furthermore, when the controllers are capable of providing haptic feedback, the haptic feedback can be tailored to reflect each device configuration, whether a controller is mated with an attachment point in the environment or an accessory, or multiple controllers are mated to each other.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY OF THE DISCLOSURE

Embodiments disclosed herein address one or more of the foregoing or other problems in the art with apparatuses, systems, and methods for connecting multiple controllers together for the purpose of transforming the input to and feedback from a telerobotic system, virtual or augmented reality system, toy system, or video game system (System). That is, input from the controllers may be interpreted differently when they are mated in a particular configuration, mated to an accessory, or to a particular mate-point in the environment, and the interpretation can also depend on the specific use case. For example, mating the controllers in a configuration with one hand behind the other (like holding a “Tommy Gun” machine gun) could make a machine gun appear onscreen in a video game, whereas in a virtual surgery simulation, this same configuration may have a 2-handed endoscope appear onscreen in the simulation (This configuration is referred to as a machine gun configuration).

Changing the mating configuration of the controllers also correspondingly changes how feedback is sent back to the controller. Audio or haptic feedback sent to the controller could be changed based on the hand configuration and use case, where haptic feedback is broadly defined meaning vibration feedback, force feedback, shear or skin stretch feedback, contact feedback, or any other type of touch feedback. For example, in a shooter-based video game, machine gun audio and haptic feedback could be portrayed on the controller when the controllers are mated in the machine gun configuration, whereas patient interaction forces in an endoscopic procedure in a surgery simulator could be portrayed on the controllers when the controllers are held in a pose that resembles a pose that a surgeon would hold an endoscope (or held in some other pre-defined pose).

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages of exemplary implementations of the disclosure will be set forth in the description which follows and in part will be obvious from the description or may be learned by the practice of such exemplary implementations. The features and advantages of such implementations may be realized and obtained by means of the instruments and combinations particularly pointed out in the appended claims. These and other features will become more fully apparent from the following description and appended claims, or may be learned by the practice of such exemplary implementations as set forth hereinafter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. For better understanding, like elements have been designated with reference numbers throughout the various accompanying figures. Understanding that these drawings depict only typical embodiments of the invention and are not therefore to be considered to be limiting of its scope, the invention will be described and explained with additional specificity and detail through the use of the accompanying drawings in which:

FIGS. 1a-1b show a light-duty peg-in-hole mate-point interface that restricts motion once mated and is used for mating controllers to each other, to accessories, or to mate-points in the environment;

FIGS. 2a-2b show a light-duty round peg-in-hole mate-point interface that allows rotary motion about the peg axis for mating controllers to each other, to accessories, or to mate-points in the environment;

FIGS. 3a-3c show a light-duty square peg-in-hole mate-point interface that allows rectilinear motion along the peg axis and is used for mating controllers to each other, to accessories, or to mate-points in the environment;

FIG. 3d shows a light-duty square peg-in-hole mate-point interface that allows rectilinear motion along the peg axis and is shown the contracted rectilinear position;

FIG. 3e shows a light-duty square peg-in-hole mate-point interface that allows rectilinear motion along the peg axis and is shown the extended position;

FIGS. 4a-4b show a light-duty round peg-in-hole mate-point interface that allows rotation about the peg axis and rectilinear motion along the peg axis and is used for mating controllers to each other, to accessories, or to mate-points in the environment;

FIGS. 5a-5b show a 2-axis gimbal depicting a 2-axis rotational joint that could be used at a mate-point for connecting controllers to each other, to accessories, or to a mate-point in the environment;

FIGS. 6a-6c show a light-duty spherical joint mate-point that allows 3 degrees of rotational freedom that could be used for connecting controllers to each other, to accessories, or to a mate-point in the environment;

FIGS. 7a-7d show a light-duty hermaphroditic mate-point that mates with translational motion between the hermaphroditic halves that does not allow relative motion once mated that could be used for connecting controllers to each other, to accessories, or to a mate-point in the environment;

FIGS. 8a-8g show a light-duty hermaphroditic mate-point that mates with a translational and rotational motion as the hermaphroditic halves approach each other that does not allow relative motion once mated that could be used for connecting controllers to each other, to accessories, or to a mate-point in the environment;

FIGS. 9a-9e show a light-duty round peg-in-hole mate-point interface that allows rotary motion about the peg axis with a magnetic center-feel feature that can be used for mating controllers to each other, to accessories, or to mate-points in the environment;

FIGS. 10a-10d show a light-duty round peg-in-hole mate-point interface that allows rotary motion about the peg axis with a magnetic center-feel feature and travel stops that can be used for mating controllers to each other, to accessories, or to mate-points in the environment;

FIGS. 11a-11h show a heavy-duty hermaphroditic rotary-locking mate-point that mates with a translational and rotational motion as the hermaphroditic halves approach each other that could be used for connecting controllers to each other, to accessories, or to a mate-point in the environment;

FIGS. 12a-12b show a heavy-duty rotary-locking mate-point with a screw thread-locking detent that includes an electrical interface that mates with a translational and rotational motion as the mate-point halves approach each other that could be used for connecting controllers to each other, to accessories, or to a mate-point in the environment;

FIGS. 13a-13c show a heavy-duty rotary-locking mate-point with a face-locking detent that includes an electrical interface that mates with a rotational motion as the mate-point halves approach each other that could be used for connecting controllers to each other, to accessories, or to a mate-point in the environment;

FIGS. 14a-14b show a heavy-duty slide-in mate-point with locking-flexure that includes an electrical interface that could be used for connecting controllers to each other, to accessories, or to a mate-point in the environment;

FIGS. 15a-15b show a heavy-duty drop-in mate-point with a rotary captive lock-nut that includes an electrical interface that could be used for connecting controllers to each other, to accessories, or to a mate-point in the environment;

FIGS. 16a-16b shows two (2) controllers mating in the fore-aft (e.g., machine gun) configuration using a light-duty round peg-in-hole mate-point interface that allows rotary motion about the peg axis with a magnetic center-feel feature and travel stops;

FIGS. 17a-17b shows two (2) controllers mating in the side-by-side medial (gamepad) configuration using a light-duty round peg-in-hole mate-point interface that allows rotary motion about the peg axis with a magnetic center-feel feature;

FIGS. 18a-18b shows two (2) controllers mating in the top-to-bottom (2-handed sword) configuration using a light-duty round peg-in-hole mate-point interface that allows rotary motion about the peg axis with a magnetic center-feel feature and travel stops;

FIGS. 19a-19b shows two (2) controllers mating in the top-to-top (handlebar) configuration using a light-duty round peg-in-hole mate-point interface that allows rotary motion about the peg axis with a magnetic center-feel feature and travel stops;

FIGS. 20a-20b shows two variants (right- and left-handed) of mate-point accessories that attach to commercially available game controllers;

FIGS. 21a-21g show a prismatic joint mate-point accessory with a travel stop that can be used with controllers with mate-points integrated into their design or with mate-point accessories (such as those shown in FIG. 20);

FIGS. 22a-22f show several possible mate-point combinations for “forming game peripherals” using mate-point accessories in combination with commercially available game controllers;

FIG. 23 illustrates an embodiment of a computer system for joining two separate controllers.

### DETAILED DESCRIPTION

One or more embodiments disclosed herein relate to mating controllers together, to accessories, or to mate-points in the environment. These controllers can be used with teleoperation, virtual reality (VR), augmented reality (AR), toy, gaming, or other systems. The present disclosure relates to mating a controller to “mate-points” or objects in the environment, mating to accessories, or to mating multiple controllers together in different configurations by joining them at one of several possible mating locations that are part of the controllers, wherein mating in one of several possible configurations can be used to transform both: (1) the way that input from the controllers is interpreted in each respective use case (e.g., mating the controllers in a machine gun configuration could make a machine gun appear onscreen in a video game), and (2) how feedback is sent back to the controller (e.g., audio or haptic feedback sent to the controller from a video game). The mating interfaces between the controllers can be tailored to prevent or allow relative motion as per desired for a specific use case and to accommodate human ergonomics.

Examples of accessories that could be mated with the controller include, but are not limited to, a tracker, a passive or actuated accessory (e.g., spring, gimbal, or motorized joint), a cosmetic item that resembles the simulated interaction (e.g., a sword blade), or other accessory items.

As an example of an environment attach point, if the user's left controller was mated with a rotating revolute attachment point in front of the user and the right controller was mated to a rotating ball joint to the right of the user, the left controller could be used as a steering wheel input and the right controller could be used as a gear shifter input. Another example of an environment attach point might be a mate-point on a virtual control panel in a standing AR or VR experience. Mating the user's controller to the mate-point on the panel could provide both inputs as if controlling that panel and feedback that specifically represents that interaction. For example, a spring-loaded 2-axis gimbal as an attach point could transform the user's controller into a very natural feeling 2-axis joystick, such that the user could pilot a ship, control a crane, etc. While these control actions could also be input just using a position-tracked controller in a VR, AR, robotic, toy, or gaming system, plugging in and attaching the controllers at a specific location in the environment can enhance the experience by assigning a specific purpose to mating with that location in the environment and help the user cognitively parse and map the interaction experience in a more intuitive manner.

Likewise, the specific axis that haptic feedback is calculated on and fed back to the user can be tailored to correspond to how the haptic feedback would be experienced when the user's hand configuration changes, e.g., as the user holds a tool/object with two hands in a pose that corresponds to a gun, steering wheel, shovel, sword, bow staff, etc. Note that the interaction forces for the user's two hands naturally change to reflect different hand poses and interactions they would have with real objects, thus the haptic feedback (e.g., haptic feedback in the form of force feedback, vibration feedback, or shear/skin stretch feedback that would be fed back to a user as a function of the user's hand configuration and interaction/activity type would also change). For example, holding a long fighting staff with one hand versus two hands provides a simple example of the change in interaction forces experienced by a user when interacting with real objects, hence the provided haptic feedback could also reflect this difference. In the case where the staff is hit (e.g., by an opponent) transversely to its length and near the end of the staff, holding the staff in one hand requires the user to oppose both the applied lateral forces and torques (or moment) that are generated when the end of the staff is hit. In contrast, when the staff is held in two hands, the user still must resist the lateral force, but a force couple generated by the user's two hands can resist the generated torque. Hence the net forces and torques experienced when holding the staff with one hand versus two hands are different, but so are the friction and shear forces (which is relevant when the controller can convey shear or skin-stretch feedback). Likewise, the vibration feedback will also be affected when the staff is hit depending on whether one or two hands grasp the staff. For example, the hand closest to the point of impact in a two-handed interaction could be fed back a larger vibration magnitude than the hand that is farther away from the collision point on the staff due to attenuation of the vibration as it travels through the staff In addition to relative hand configuration of controllers when interacting, selectively constraining relative motion of or between controllers can also be advantageous.

Designing the mechanical connection between the controllers to have specific degrees of freedom (DOF) can be used to tailor the input to the System (VR, AR, telerobot, toy, or gaming systems). Allowed degrees-of-freedom of motion at the mating interfaces can be used as an input to the use case. For example, a rotation about an axis of the controllers could be used to simulate the throttle on the handle bars of a motor cycle. Allowed degrees-of-freedom of motion at the mating interfaces can also be used to accommodate ergonomic variation among people as well as variations in relative hand pose between the controllers. The user moves the controllers while the controllers are mated without the need to re-grip or shift the user's grip on the controllers.

The orientation and location of the mate-points on the controller can be placed in an ergonomic mating location where the hands naturally come together in a particular body/arm pose so that the controllers are comfortable to hold in this position and so that it is advantageous for finding the mate-points without directly looking at one's hands (“blind mating”). For example, in at least one embodiment, a user may be wearing a head-mounted display that completely occludes the user's view. In such a case, the user is still able to mate controllers without looking at his/her hands. The use of magnets and guiding geometric features, such as a peg and mating conical hole (or the use of other passive or active features) can further aid the user in mating the controllers without directly looking at their hands or the controllers. Furthermore, magnets can help the user maintain a connection between the controllers when the controllers are mated, which is especially helpful when the user is moving his/her arms. To avoid magnets from making contact with other objects in the environment, especially ferrous magnetic materials, steel or other ferrous material may be used on one side of the magnetic guiding interface. Placing the magnet in the most isolated or female side of the magnetically guided mating features may be desirable for this reason, with the mating half of the interface utilizing a ferrous material component for making contact with the mating magnet.

In addition, the mate-points should not interfere with the person's arms or with hand/arm motions. At the same time, the attachment points can be placed as close as possible to the middle of their hands so as to promote better mating accuracy (especially for “blind mating”) since people's proprioception for bringing their hands together (i.e. mating their hands) is much better when making contact between their hands (or a point on their body) as opposed to mating a point that is remote and outside of the actual hand. Furthermore, the attachment points should place the user's hands in a comfortable ergonomic pose once mated while keeping the user's hands space far enough apart to not interfere or collide with the body of the controller on the opposite hand or items in the environment (in the case of a mate-point in the environment). As a compromise between the requirements of not interfering with the user's hand or natural hand motions, being in an ergonomic pose once mated, and keeping attachment points as close to the center of the hand as possible, placing attachment points in-line with a point slightly above the user's hand provides clearance for the user's forearm (e.g., in a machine gun pose) while still being along a natural trajectory for the hands to approach each other for mating the controllers together. The mate-points can be placed above the user's hands, but their hands still approach each other as if they are making contact between their hands with the mate-points in line with the approach trajectory of their hands.

The general locations for mate-points on controllers of main interest for interaction with VR, AR, robotic, toy, and gaming systems include, but are not limited to, the top, bottom, front, back and medial side of the controller (medial meaning facing the centerline of a person, i.e. the left side of the right controller and right side of the left controller. The medial side connections form a side-by-side configuration similar to a gamepad). Note that because of human ergonomics, limb configuration, kinematics, and motion, the exact location and orientation of the mate-points should be tailored as mentioned above and as illustrated in the examples that follow. For example, when mating two controllers using the medial mate-points (i.e. side-by-side configuration) to form a configuration and pose similar to a modern 2-handed game pad, the mate-points should allow the users hands and wrists to be angled toward the centerline similar to the angle of their forearms, just as modern game controllers do. Such a mating configuration could be used to mimic a steering wheel, flight yoke, deck machine gun, game pad, etc.

Attaching the front mate-point of the right controller to the back mate-point of the left controller (i.e. front-to-back) requires similar ergonomic considerations. That is, aligning the forward axis of the individual controllers to each other would be uncomfortable for the user's wrists, so having a mate-point on the front of the right controller attach to a mate-point projecting out of the left controller that is oriented toward the back and right provides a more comfortable pose when the controllers are mated and a more natural location for the user to reach out toward when mating the controllers. The front-to-back mating configuration could be used to mimic a machine gun, flame thrower, endoscope, saw, etc.

Mating controllers top-to-top forms an interface that resembles a user's hand pose on a bicycle or motor cycle handlebar, bow staff, chin-up bar, weight-lifting bar, lawn mower handle, shopping cart, baby stroller, bob sled, snow mobile, 4-wheeler motor vehicle, etc. These mate interfaces can stick directly out of the controller top but may result in a more comfortable pose if the mounts allow the user's hands to angle downward as they extend away from the center.

Mating controllers in a top-to-bottom configuration resembles the hand pose when using a shovel, 2-handed sword, fighting staff, spear, pole-arm, flag, etc. Note that the comfort of this mated configuration can be improved by rotating (clocking) this mate interface about a rotation axis along the length of the controller to allow the user's wrists to more closely follow the angle of their forearms, i.e. angle outward toward their shoulders.

The controller configurations described above are purely for example and do not limiting the scope of this invention. They are meant to be purely illustrative and provide tangible examples of the invention in practice

Furthermore, the releasing (or allowing) of a degree of freedom between the controllers in the above device configurations or when attached to the environment provides an opportunity for additional input to the System and can provide a very natural input for the user (e.g., people are used to the notion of turning the grip on a motor cycle to go faster). While tracked, tetherless controllers are versatile and can be used to represent most interactions, the presence of some mechanical structure to confine the motions of an interaction can aid in adding realism, immersion, and acceptance of the user.

The allowed degrees of freedom could be sensed either by tracking the controllers relative to each other, tracking the controllers relative to the environment mate-point (e.g., through a potentiometer on a gimbal), or by tracking the controllers individually and calculating the relative motion with respect to each other or the environment. The allowed degrees of freedom between controllers or between the controller and the environment or accessory can be tailored as desired through the use of appropriate mechanical designs at the mate-points or as an accessory added between the mate-points, e.g., revolute joints, universal joints, ball joints, prismatic joints, combinations thereof, etc.

An example of a revolute degree of freedom input would be for use as a motor cycle throttle input when controllers are mated in a top-to-top configuration and rotation is allowed along the length of the handle (i.e. the handlebar axis). A revolute degree of freedom could also be isolated and used between controllers in the side-by-side (medial mate-point) game-pad configuration. This degree of freedom could be used again as a throttle input or in place of tank-style steering (which is typically accomplished with side-by-side levers). An example of a revolute degree of freedom used as an input in the front-back mating between controllers could be as a control valve for a flame thrower, where the relative rotation about the rotational degree of freedom is approximately parallel with the axis of the barrel of the flamethrower. Rotating one direction could increase the flame thrower output and rotating the opposite direction could reduce the output.

In addition to allowed degrees of freedom being useful as an additional input, they can also be useful for accommodating ergonomic differences between people based on their limb size, etc. For example, the angle between users' hands when they bring them together may be different based on the size of the person.

Furthermore, allowed degrees of freedom between the controllers, accessory, or the environment can also accommodate the change in arm/hand angle when the user's hands grasp the joined controllers and the user moves through the range of motion of their arms. For example, when joining one's hands as if praying and then moving their hands toward or away from their chest the angle between their forearms becomes smaller and more parallel (when viewed from an overhead view). The same angle change occurs when a user grabs a single handle, e.g., a two-handed sword handle, and moves through a range of motion. In the case of the 2-handed sword, the user's hands must slip around/about the handle as the move through a range of motion to avert uncomfortable wrist strain. When controllers are grasped by the user and mated together, the same relative angle change of their arms occurs. While some of this relative rotation can be accommodated by rotation at the wrists, having a rotational degree of freedom at the attach points can provide a more comfortable experience for the user and not require them to regrip the device (regripping may not be advantageous as it can add an offset to the tracked position of the user's controller or could impact some types of haptic feedback).

While allowing specific degrees of freedom between the controllers or controller and accessory/environment can be advantageous for ergonomic or input reasons, it can lead to a loss of how “solidly” the users perceive the controllers are connected, which can reduce their belief that the joined controllers feel like the object they are controlling or seeing in the virtual, augmented, game, robotic, or teleoperated experience. Travel stops can be implemented to confine the total rotation or translational motion allowed at these mate-points. These travel stops can provide an intuitive sense of range and allow users to quickly map the range of “fully on” and “fully off” when controlling programmed tasks. By placing the travel stops near the end of range that a user naturally holds their hands, the user can bias their hand pose to push or rest against these stops (e.g., resting against a rotational stop with top-to-bottom mated controllers while holding a virtual shovel), which can restore the sense that the user is holding a rigid object, despite rotation being allowed between the controllers. Another example would be to place rotational stops for the front-to-back machine gun mate-points such that one rational stop near the natural pose when the user's hands are resting near their body, and place the rotational stop at the other end of the rotation range to correspond with their relative wrist rotation when they have raise their “virtual gun” and are looking down its barrel.

The “feel” of the allowed degrees-of-freedom at the mate interfaces can also be tailored through the addition of mechanical features or one or more components such as, but not limited to, magnets, dampers, springs, and/or actuators within the mate interface or within an accessory placed in or between the mate interfaces. These additional features can be used to create the sense of viscosity or springiness when moving the controllers relative to each other or the accessory/environment on the allowed degree of freedom, or may give an indication of the center position or preferred position between travel stops on the mating interface. As an example, this center or preferred position on the allowed degree of freedom can be indicated to the user by a bi-stable mechanism such as the spring-cam interface found within house-hold light switches. A spring-loaded ball detent sliding on the surface of the mating interface could also be used to indicate a preferred position. Pairs of magnets on the mating interface could also indicate preferred position along the allowed degree(s) of freedom of the mate-point. Pairs of magnets can also be added at the travel stops (or other pre-determined locations) of the allowed degree(s) of freedom to make the ends-of-travel (or other pre-determined locations) feel sticky and/or make the mated controllers feel more stable or rigid when held in this orientation. The feel of the motion at the mate interface can also be tailored by controlling the surface friction or texture at the mate-point interface. All of the above effects can also be portrayed by placing a controlled actuation mechanism at or in between the mating interfaces to provide centering, springy, damped, sticky, rigid, or other simulated behavior of the allowed degree of freedom of the mate-point.

Being able to directly see the controllers during mating, or providing guidance in VR environments can further aid in the mating of controllers. However, if the tracking system used in the VR system has tracking inaccuracies in it, only providing the coarse features is more advantageous than providing detailed representation and location of mate-points. If a more coarse (lower resolution) representation is used, magnetic or geometric features can be effective in aiding the user with mating the controllers to each other or the environment. However, if the exact mate-point is represented and tracking accuracy is poor, the user's increased confidence in exactly where to move the controllers can place their actual position outside of the range in which the magnetic or geometric guiding features can aid them, and/or they may fight against these guiding features since they seem to be guiding them away from where they need to move to mate the controller(s).

In some cases, it can be advantageous to mate the controller before an interaction session. In this case, the use of more heavy-duty mate-point interconnects is possible, as opposed to lighter-duty interfaces that are easily separable on-the-fly. A stronger, heavy-duty mount can be made to feel like a permanent connection and replace the need to purchase separate peripherals for specific use cases (e.g., gun peripheral, steering wheel peripheral, etc.). The heavy-duty interfaces could utilize traditional screws, bolts, or other fasteners and more conveniently would employ designs that can still be quickly released, such as a twist- or slide-and-lock interface with a release lever, quarter-turn lug design, etc.

A heavy-duty interface can also make it convenient to provide electrical connections between the controllers, attachments, and/or environmental mate-points. These electrical signals could include power, communication lines (e.g., wired serial, nearfield serial communication, RFID tags), etc. Standard electrical interfaces such as pogo pins, spring pins, slip rings, etc. could be utilized to connect electrical signals across the mated interfaces. Electrical signals could also be connected across light-duty on-the-fly mating interfaces (e.g., power and ground, which could be used to recharge the controller device while mated with an environment mate-point such as a dashboard, steering wheel, shifter, or joystick).

The mated configuration of the controllers can be detected by on-controller sensors (e.g., continuity, magnet/hall effect pairs, or optical emitter/detector pairs) or by tracking the locations of each of the controllers (e.g., through optical, inertial, magnetic tracking, or a hybrid of these tracking methods) and deducing that a mated connection has been made between the controllers based on their relative pose and proximity. In such a case, it is not necessary for any sensors that are internal to the controllers to directly detect the physical mating. Instead, an external tracking system and/or positional sensors within the controllers can detect that the controllers are being held relative to each other in such a pose that it is inferred that they are mated. A magnet on the controllers at the mating interfaces can help ensure a stable connection between the controllers. In the case where a connection is inferred between the controllers based on tracking the controller individually, placing a magnet at the mating interfaces can improve the prediction that controllers are mated.

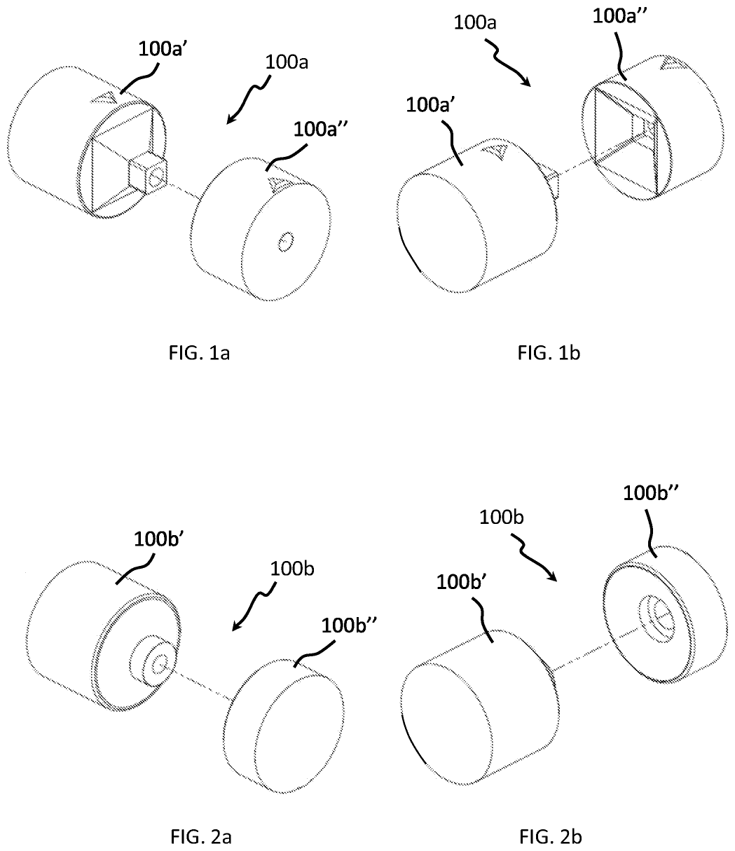

A large variety of mate-points can be utilized, including but not limited to the interfaces shown in FIGS. 1a through 15b. The mate-points presented herein are subdivided into “light-duty” and “heavy-duty” mate-points. Light-duty mate-points can be easily connected or disconnected on the fly and can potentially be “blind-mated” (i.e. not require the user to look at the mating interface while mating controllers). In contrast, heavy-duty mate-points can be more permanent, stiffer, and remain mated under heavier loads without de-mating under the same conditions as light-duty mate-points. Heavy-duty mate-points are also better suited for providing a means to carry electrical power or electrical signals across the mate-point. Light-duty mate-points can also be used to carry electrical signals across a mate-point, but greater care may be required and the mate-point may not support as many signals across the interface.

A simple mate-point (e.g., 100a, 100b, 100h, 100i) resembles a peg-in-hole (or peg and hole) interface, as shown in FIGS. 1a-1b, 2a-2b, 9a-9e, and 10a-10d, where the halves of the mate-point are mated by moving along the dashed centerline shown in the figures. The dashed centerline indicates the axis along which the mate-point is mated in FIGS. 1a-19b. The mate-point interfaces (100a, 100b, 100c, 100d, 100e, 100h, 100i) shown in FIGS. 1a-1b, 2a-2b, 3a-3e, 4a-4b, 6a-6c, 9a-9e, 10a-10d also add features to help guide the mating operation in the form of centering the hole inside of a conical depression. The conical feature creates a bigger target for the peg and acts as a funnel to aid the user in finding and mating with the hole. A magnet at the tip of the peg and base of the hole further attracts and helps guide the user to mate the peg with the hole. A piece of ferrous material, e.g., steel, may be substituted for either of the magnets. Replacing the magnet on the peg (or generally replacing the most outboard magnet) with ferrous material can be advantageous as it reduces the likelihood of the controller accidentally sticking to ferrous objects in the environment (since the remaining magnet is recessed from the outside of the controller).

In addition to simply providing a connection, mate-points can be used to specifically control the allowed motions (degrees of freedom) once mated. In particular, the light-duty mate-point 100a in FIGS. 1a and 1b utilizes a square peg 100a′ and hole 100a″ mate-point, which does not allow relative rotation or translation once mated (until the mate-point is separated). In contrast, the round peg 100b′ and hole 100b″ light-duty mate-point interface 100b shown in FIGS. 2a and 2b allows a rotational degree of freedom about the axis of the peg, which can be advantageous by transforming the relative motion between the controllers or controller and accessory/environment as a natural motion input to the system (e.g., a rotation between controller could be used as a throttle input for a motor cycle simulation).

In general, the relative motion input can be sensed by sensors embedded in the controller, accessory, or environment using a potentiometer, encoder, hall-effect sensor or other means known in the art. The relative motion of the mate-point can also be sensed by sensing/tracking the position/orientation of the individual controllers, accessories, or environment mate-points and calculating the relative motion. This tracking can be accomplished via optical tracking, inertial tracking, inductive tracking, capacitive tracking, magnetic tracking, hybrids of these tracking methods, or other methods.

In addition to using the mate-point allowed degrees of freedom as a system input, the allowed degrees of freedom can also be used for accommodating ergonomic variation (e.g., size) across users. The allowed degrees of freedom can also allow more comfortable ergonomics when mating the controllers and moving them within the user's range of motion with their arms. Allowing relative motions between the controllers permits a user to maintain his/her grip on the controllers without the need to regrip or slide their grip (regripping may not be advantageous when haptic feedback is provided through the controller).

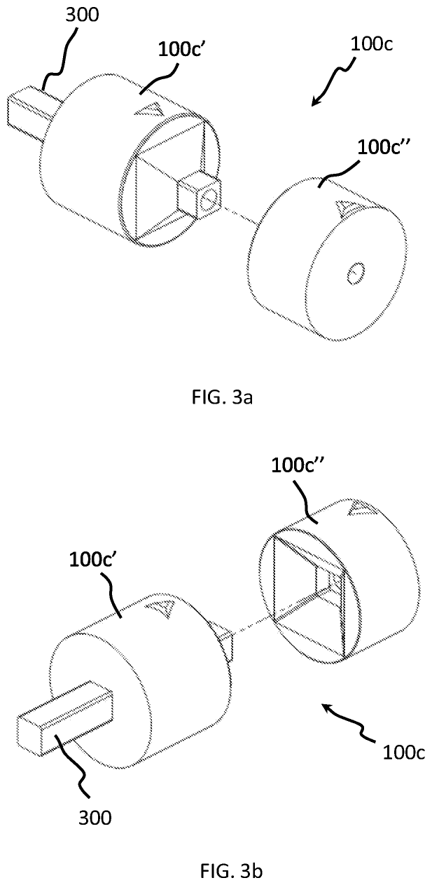

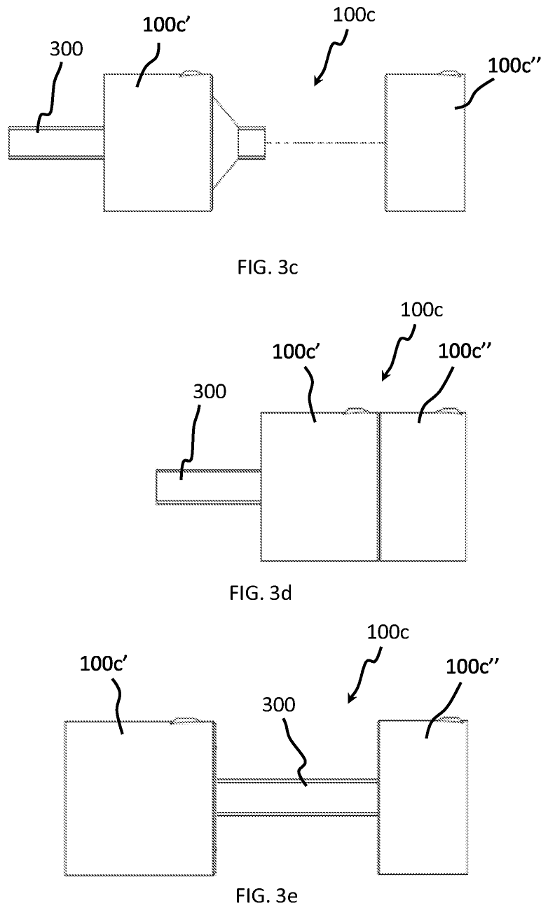

The mate-point design 100c shown in FIGS. 3a-3e builds on the design shown in FIGS. 1a-1b. The design shown in FIGS. 3a-3e adds a telescoping, prismatic degree of freedom 300 to the interface. FIGS. 3d and 3e show the mate-point 100c in its mated configuration. FIG. 3d shows the interface 100c in the contracted position, whereas FIG. 3e shows the interface in the extended position. This implementation of this prismatic joint mate-point leaves the conical base of the magnet-tipped peg in contact with the conical seat to add stability to the mated connection.

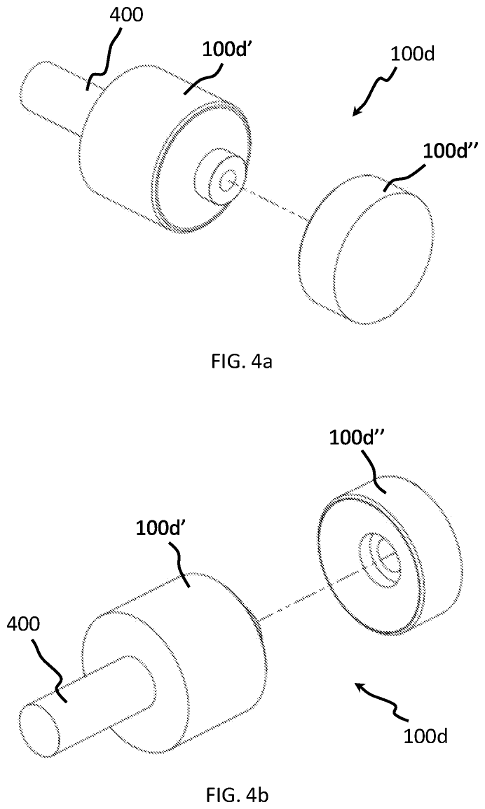

The mate-point design 100d shown in FIGS. 4a and 4b builds on the design 100b shown in FIGS. 2a and 2b. The design shown in FIGS. 4a and 4b adds a telescoping, prismatic degree of freedom 400 to the interface and has both a rotational and prismatic degree of freedom. It functions similarly to the design 100c shown in FIGS. 3a-3e with the addition of rotation. This implementation of this prismatic mate-point leaves the conical base of the magnet-tipped peg in contact with the conical seat to add stability to the mated connection.

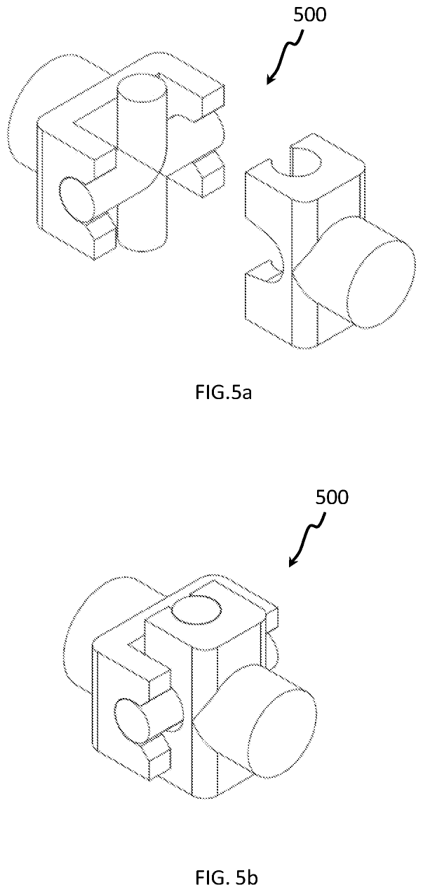

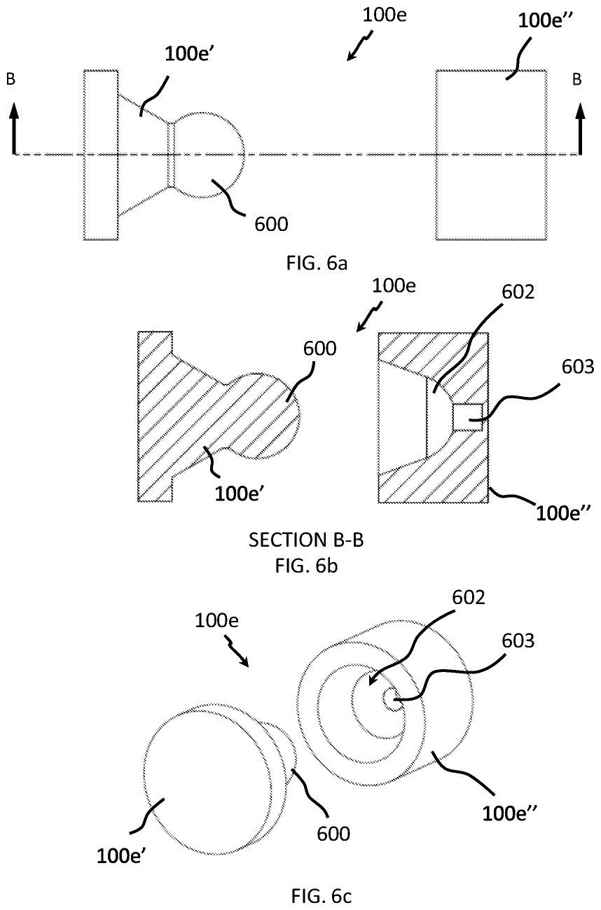

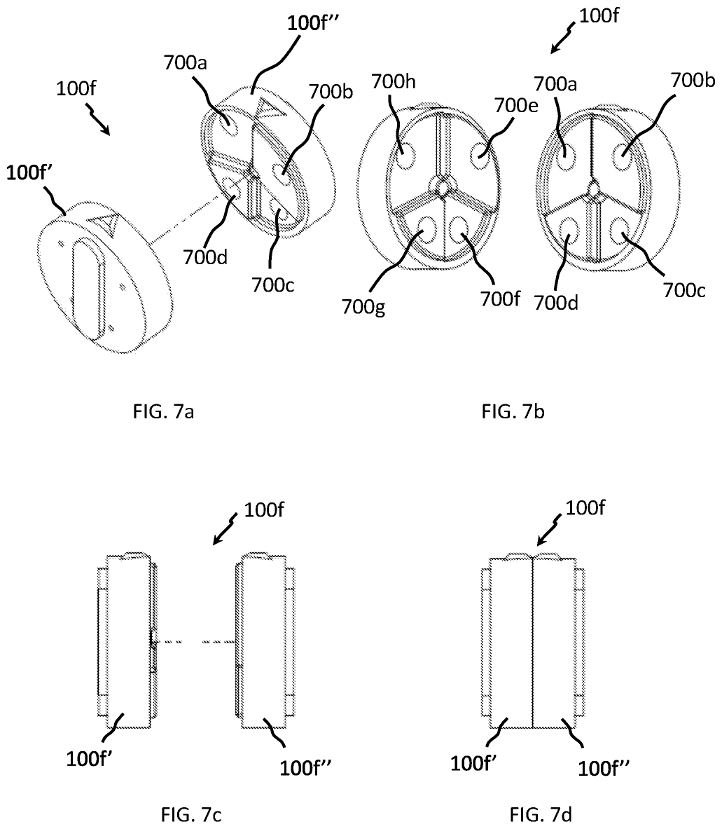

As seen in FIGS. 4a and 4b, multiple degrees of freedom can be combined. FIGS. 5a and 5b show an interface that combines two rotational degrees of freedom 500 and can be placed at or in between mate-points as an accessory. An additional rotational degree of freedom can be added through the use of a universal joint, which would add a rotational degree of freedom about the axis exiting the gimbal shown in FIG. 5b. Another approach is shown in FIGS. 6a-6c, which depicts a spherical joint mate-point 100e. This design can use a magnetic ball 600 and magnet 603 at the base of the spherical socket 602. It may also be implemented with a ferrous ball 600 and only a magnet at the base of the spherical socket. This design also features a conical lead-in to the spherical socket to create a larger target for the user to mate the ball and guide the user to the mated position.

Whereas all of the preceding mate-point designs have utilized asymmetric interface designs (e.g., male peg, female hole), it can be advantageous to have a mate-point which utilizes the same geometry on both sides of the interface (i.e. a hermaphroditic interface design). This is advantageous as this allows these hermaphroditic interfaces to be placed without regard to foreknowledge of how they will be combined and mated. FIGS. 7a-7d show an example of a light-weight hermaphroditic mate-point interface 100f. They show a design that can be mated by moving one of the interface pieces 100f toward the other 100f″. FIG. 7d shows the mate-point in its mated configuration. As shown, it can be mated only in a single orientation, however, it could be designed with 90-degree segments to allow it to be mated in more than one orientation. In addition, more segments could be added to allow more mating orientations. The hermaphroditic interface shown in FIGS. 7a-7d utilize magnets at 4 locations, for a total of 8 magnets 700a-700h when the two halves are mated. Note that four of the magnets could be replaced with a ferrous material. For example, one of the halves could have only ferrous material in place of the magnets. Another more advantageous configuration would place two magnets in each of the hermaphroditic halves in the recessed locations of each (to reduce the likelihood of sticking to metal objects in the environment). In another embodiment, the number of magnets could be reduced from eight total to four total (e.g., at the recessed locations on one of the hermaphroditic halves and the protruding locations on the other hermaphroditic half). This configuration can be less stable but can still hold the interface together. In addition, two of these four magnets could be replaced with ferrous material (e.g., the 2 on the protruding locations).

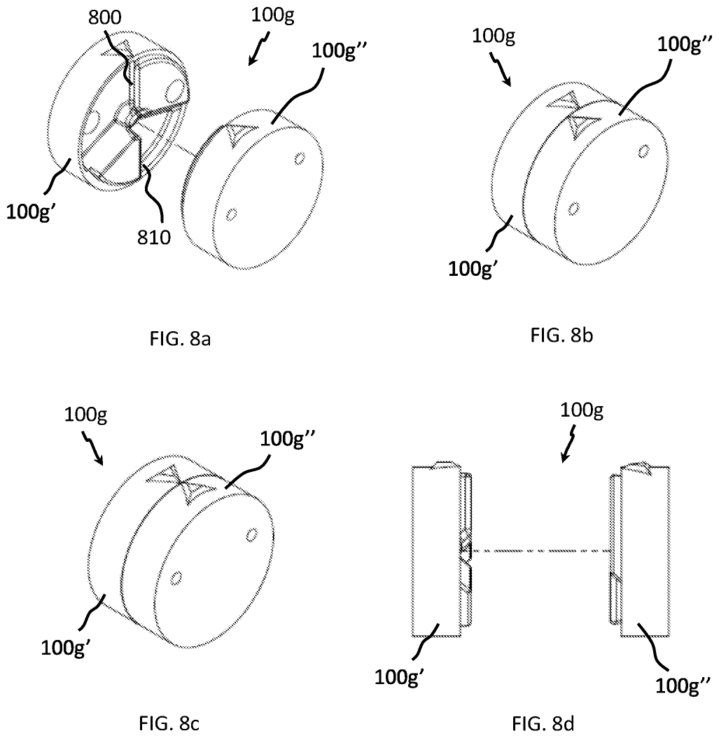

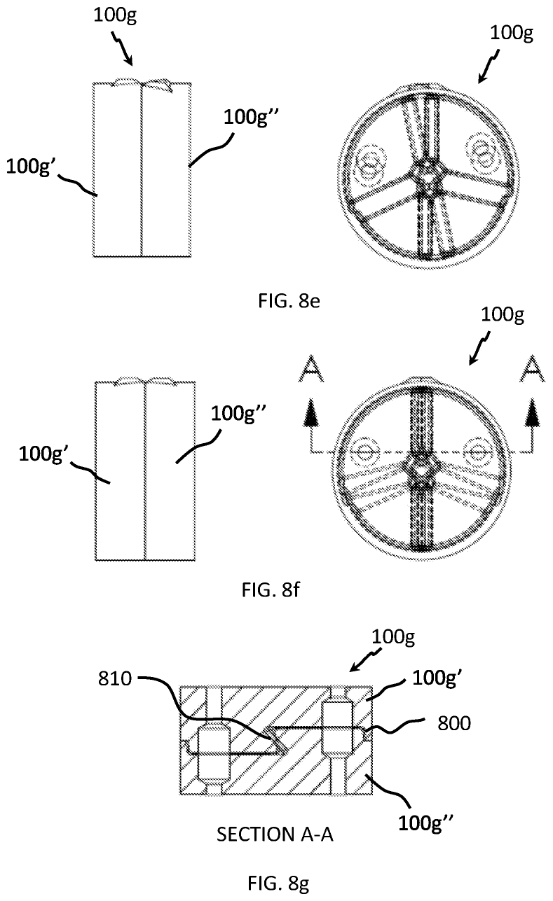

Another example of a light-weight hermaphroditic mate-point 100g is shown in FIGS. 8a-8g, which is similar to the light-weight hermaphroditic mate-point shown in FIGS. 7a-7d; however, the hermaphroditic mate-point shown in FIGS. 8a-8g incorporates a rotary pseudo-lock feature similar to a quarter-turn fastener. FIGS. 8b and 8e show the mate-point with mating halves 100g′, 100g″ in contact and FIGS. 8c, 8f, and 8g show the mate-point rotated into its mated and locked position. The surfaces that enable the quarter turn locking are designated 800 and 810 in FIGS. 8a and 8g. While the rotary motion during mating increases the difficulty of blind-mating this design, it can provide a more secure mate than the straight-on mating design shown in FIGS. 7a-7d. This design can also reduce the number of magnets utilized relative to the interface 100f shown in FIGS. 7a-7d.

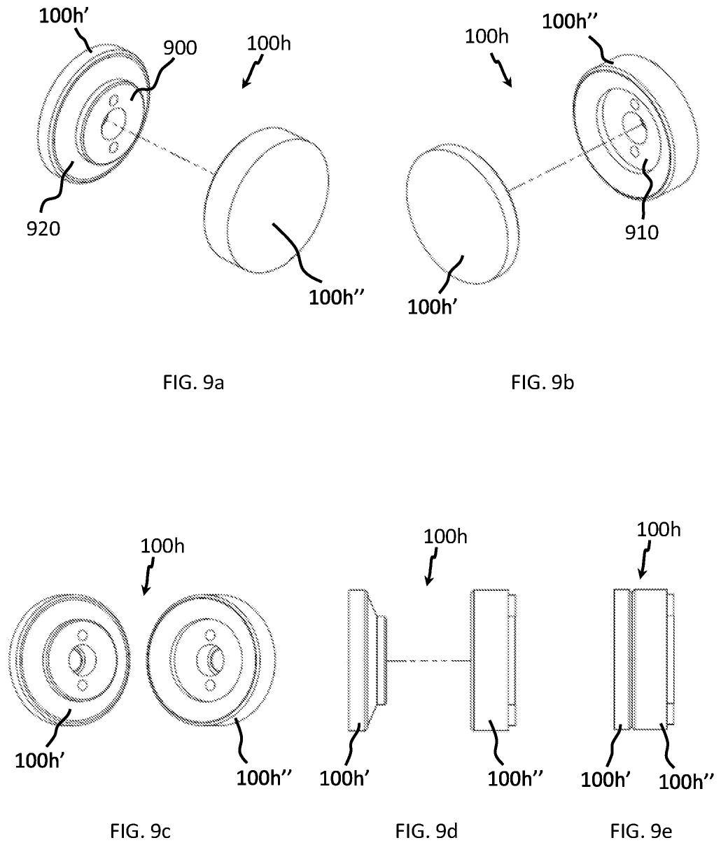

In contrast, the mate-point design shown in FIGS. 9a-9e returns to the simpler design concept shown in FIGS. 2a and 2b with scaling of the interface that is meant to be size-appropriate and space efficient for hand-controller-sized devices. The peg and hole mate-point design 100h shown in FIGS. 9a-9e incorporates a stubby peg 900 and hole 910, wide lead-in cone 920, and broad base to maximize the interface stability when mated. FIG. 9e shows the mate-point 100h in its mated configuration. This design also incorporates a pair of magnets radially opposed to each other to provide a “center feel” to this rotary joint. Other mechanical solutions, including but not limited to, a torsional spring, ball detent and groove, or cam-spring could be used to provide such a “center feel” for the mate-point. Likewise, the mating surfaces of the mate-point interface could be textured or treated to increase or decrease rotational resistance at the interface. Mechanical components such as dampers, motors, etc. could be incorporated into the halves of a mate-point interface or as an accessory to sense and/or feedback a desired mechanical “feel” at a mate-point.

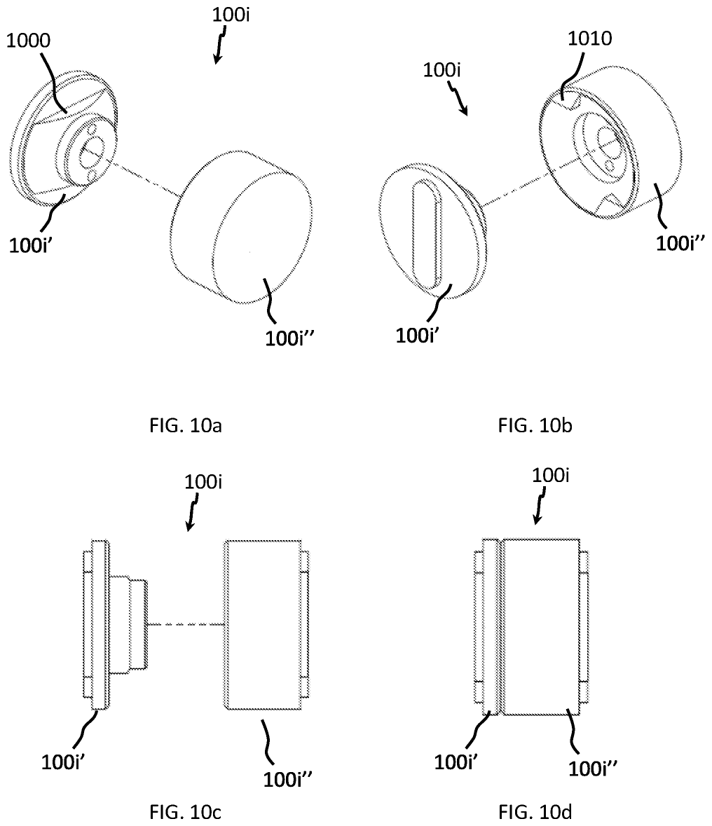

The interface design 100i shown in FIGS. 10a-10d further build on that shown in FIGS. 9a-9e by incorporating rotational stops 1000 and 1010 which can be implemented in a variety of ways. FIG. 10d shows the mate-point 100i in its mated configuration. The inclusion of rotational stops has several advantages. The rotational stops can be helpful for communicating with users the total range of input so that they can scale their motions appropriately for the desired interaction. Placing rotational stops 1000/1010 near the bounds of natural device rotation can also allow users to “brace” against these rotations stops to give a greater sense of rigidity to the mated devices. In addition to rotational stops, any allowed degree of freedom could incorporate travel stops.

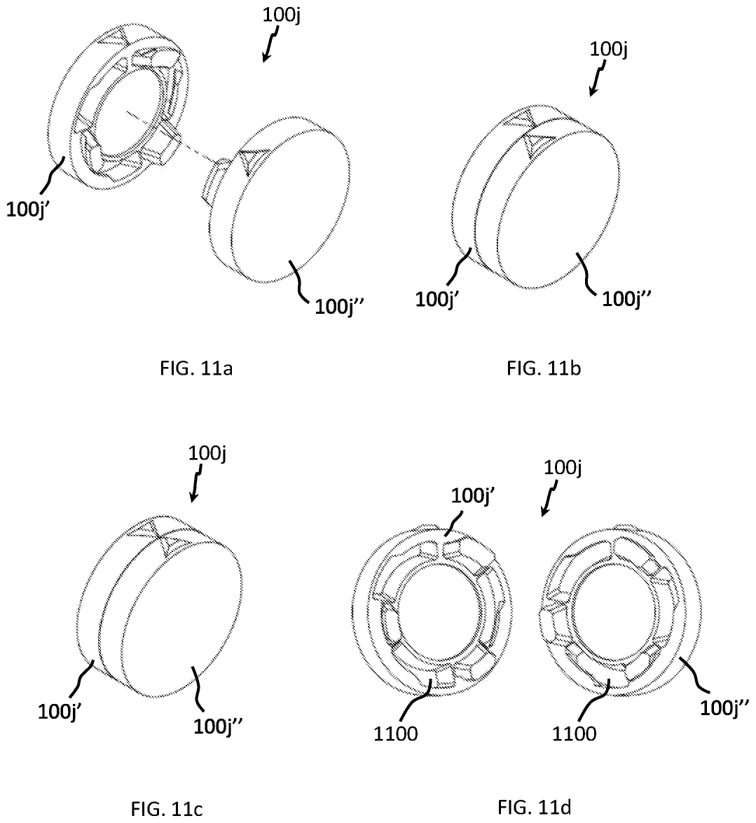

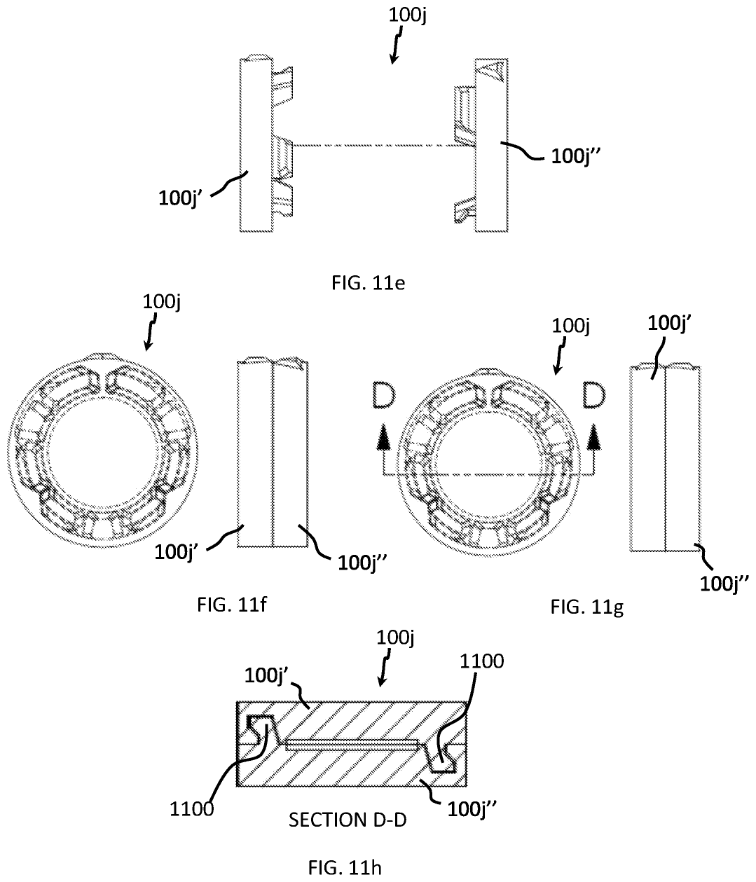

In additional to light-duty interfaces, which a user can easily mate on-the-fly, heavy-duty interfaces can also be useful for attaching multiple controllers together or attaching controllers to accessories or the environment in a more permanent and/or rigid manner than possible with interfaces that can be easily mated on-the-fly or even blind-mated. An example of a heavy-duty hermaphroditic interface 100j is shown in FIGS. 11a-11h. Both sides of the mate-point interface have the same geometry. The design shown in FIGS. 11a-11h is locked using a small rotary motion as the two halves approach each other, similar to a quarter-turn fastener. FIGS. 11b and 11f show the mate-point with mating halves in contact and FIGS. 11c, 11g, and 11h show the mate-point rotated into the mated and locked position with wedged locking surfaces 1100 engaged.

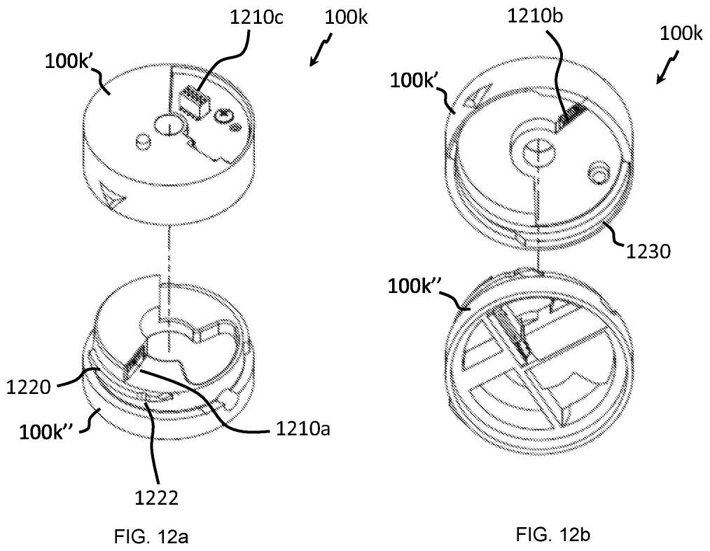

Another example of a heavy-duty mate-point 100k is shown in FIGS. 12a and 12b, which also locks in place using a rotary motion as the two halves approach each other in a manner similar to a quarter-turn fastener. This design uses a thread engagement 1220/1230 that incorporates a detent 1222 feature within the thread. The design is also capable of passing electrical signals through it. As the interface is rotated and locked into place, electrical contacts from one side of the interface 1210a makes contact with the electrical contacts on the other side 1210b. Spring clips, pogo-pins, or similar items can be used to form a reliable electrical connection for conveying power or electrical signals. An electrical connector 1210c can be incorporated into one of the halves for plugging in external electronics or devices.

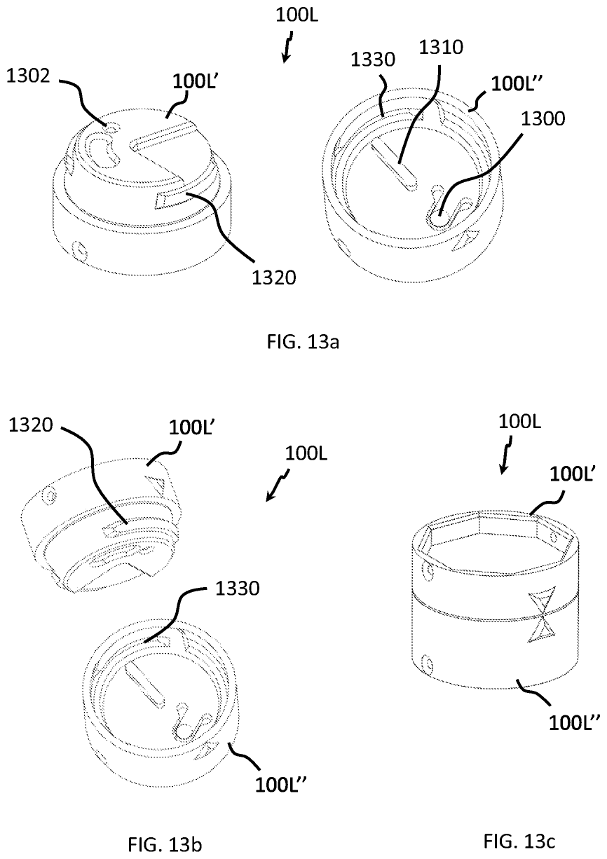

FIGS. 13a-13c show another example of a heavy-duty mate-point 100L that can also provide electrical connections 1310 across the mate-point. In contrast to the interface design shown in FIGS. 12a and 12b, the design in FIGS. 13a-13c utilizes a cantilever-sprung detent 1300 that slides along the underside of the mating surface and falls into a depression 1302 once the mate is rotated and locked into place. A screw thread 1320/1330 is used as the locking mechanism, which can be locked into place with approximately a quarter of a turn. FIG. 13c shows the mate-point rotated into its mated and locked position.

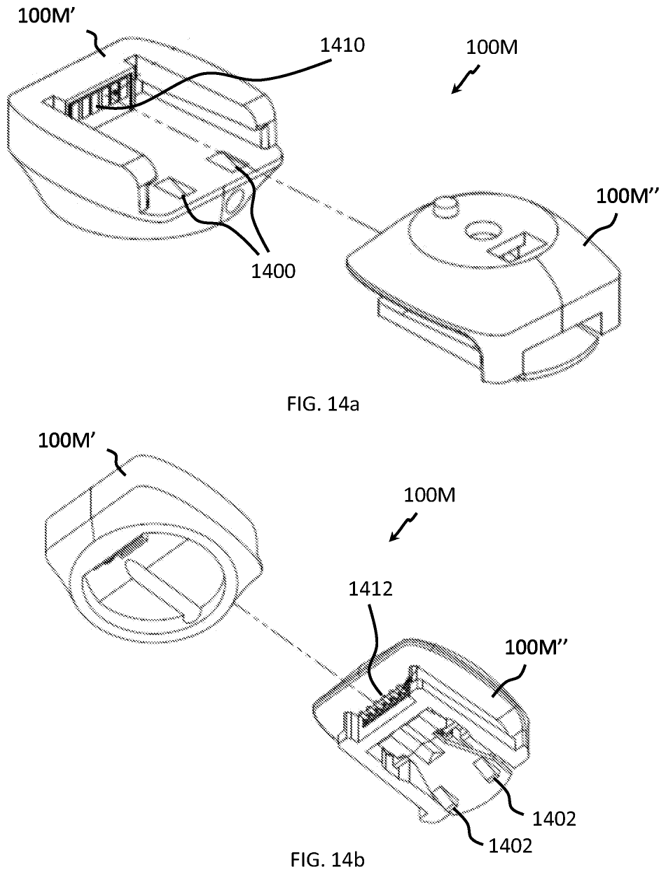

In contrast to the prior heavy-duty mate-points, FIGS. 14a and 14b show a heavy-duty mate-point 100M that slides in place from the side, as shown by the dashed centerline in FIGS. 14a and 14b, and has a spring-loaded latch to hold it in place or release the interface. The sliding interface incorporates a sliding wedge 1402 that wedges and makes a secure joint as the interface is mated in the wedge grooves 1400. In addition, the interface also incorporates an electrical connection 1410/1412 that makes contact once mated. Spring clips, pogo-pins, or similar can be used to form a reliable electrical connection for conveying power or electrical signals.

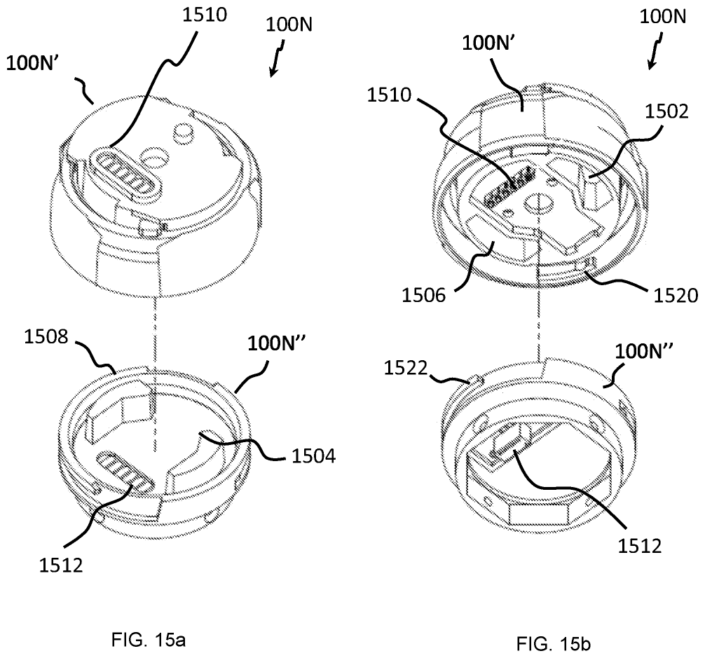

FIGS. 15a and 15b also show a heavy-duty mate-point 100N that mates by moving the two halves 100N′ and 100N″ toward each other in a direction normal to their circular faces. Once pressed into each other, interdigitated portions (1502, 1504, 1506, and 1508) of the two halves carry shear forces, while a captive nut 1520 locks the interface together by engaging mating threads 1522. This captive nut can be designed to utilize several rotations or could be design for very little rotation (e.g., a quarter-turn fastener). Electrical signals can be carried across the mated interface 1510/1512 using spring clips, pogo-pins, or similar items to form reliable electrical connections for conveying power or electrical signals.

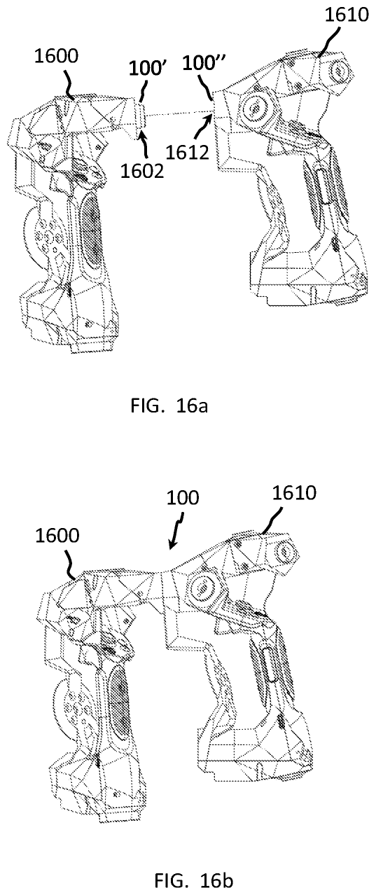

Several other light-duty and heavy-duty designs could be utilized. FIGS. 16a-16b, 20a-20b, and 21a-21g show several typical examples of utilizing these mate-point interfaces. These figures show examples of mating controllers using the light-duty peg-in-hole mate-point interface using the interface designs shown in FIGS. 9a-9e and 10a-10d, while also incorporating the heavy-duty mate-point interface shown in FIGS. 14a and 14b. However, other mate-point designs, such as shown in FIGS. 1a-15b, could also be incorporated to connect controllers together.

FIGS. 16a and 16b depict a left controller 1600 and a right controller 1610. The left controller 1600 comprises a mate-point 100′ in the form of a medial/rear mate-point 1602. Similarly, the right controller 1610 comprises a mate-point 100″ in the form of a front mate-point 1612. One will appreciate, in view of the present disclosure, that mate-point 100′ and mate-point 100″ may comprise any mutually compatible mate-point 100 disclosed herein. As such, the description of the left medial/rear mate-point 1602 and the right front mate-point 1612 is provided for the sake of example and explanation regarding the relative placement of mate-points 100′ and 100″ and is not meant to necessarily indicate a particular type of mate-point 100 must be used.

FIGS. 16a and 16b show two controllers mated in the fore-aft (machine gun) mate-point configuration using a peg-in-hole mate-point interface 100h, as shown in FIGS. 2a-2b, 9a-9e, and 10a-10d. This mated controller configuration may be useful for interaction and input for a machine gun, rifle, shotgun, flame thrower, surgical instrument, etc. The controllers are mated by bringing together the mate-point on the front of one controller with the mate-point on the back of a second controller along the dashed centerline as shown in FIG. 16a. FIG. 16a shows the controllers with the left controller in front of the right controller, whereas FIG. 16b shows the controllers with their respective mate-points mated. The controllers could also be mated with the right controller in front of the left. Utilizing a circular peg and hole mate-point allows for an additional rotational degree of input for this “machine gun” configuration. For example, if a game were to have a flame thrower, the rotational degree of freedom about an axis approximately parallel to the gun-barrel axis could be used as a throttle input to increase or decrease the amount of flames being projected. The rotational degree of freedom also accommodates the natural relative rotation between the user's hands as they move through their arm's workspace (e.g., from a resting position of the mated controllers against their body to the extended position of the controllers when the user is “aiming” down the “barrel” of their simulated gun). The rotational degree of freedom can also accommodate differences in size and other ergonomic considerations better than if a single rotary angle were chosen. In addition, rotary stops may be added to the peg-in-hole mate-point to provide the user a sense of “range” of input for scaling their input actions to the controlled System. These motion stops can also provide points for the user to brace against to make the rotary mate-point feel more rigid and sturdy.

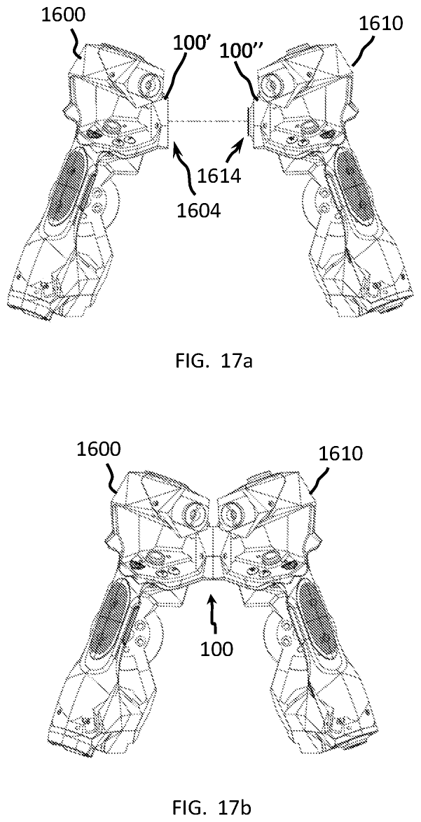

FIGS. 17a and 17b depict a left controller 1600 and a right controller 1610. The left controller 1600 comprises a mate-point 100′ in the form of a left medial mate-point 1604. Similarly, the right controller 1610 comprises a mate-point 100″ in the form of a right medial mate-point 1614. One will appreciate, in view of the present disclosure, that mate-point 100′ and mate-point 100″ may comprise any mutually compatible mate-point 100 disclosed herein. As such, the description of the left medial mate-point 1604 and the right medial mate-point 1614 is provided for the sake of example and explanation regarding the relative placement of mate-points 100′ and 100″ and is not meant to necessarily indicate a particular type of mate-point 100 must be used.

FIGS. 17a and 17b show two controllers mated in the side-by-side, medial (gamepad) mate-point configuration 100h using a peg-in-hole mate-point interface, as shown in FIGS. 9a-9e. This mated controller configuration may be useful for interaction and input for a gamepad, steering wheel, flight yoke, etc. The controllers are mated by bringing together the mate-point on the left of the right controller with the mate-point on the right of the left controller along the dashed centerline as shown in FIG. 17a. FIG. 17b shows the controllers with their respective mate-points mated. Utilizing a circular peg and hole mate-point allows for an additional rotational degree of input for this “gamepad” configuration. For example, if a game were to have a motorcycle throttle in a game, the rotational degree of freedom about the peg axis could be used as a very natural throttle input to increase or decrease the motorcycle's speed in the game or simulation. The rotational degree of freedom also accommodates the natural relative rotation between the user's hands as they hold the controllers in different arm poses (e.g., from a resting position of the mated controllers against their body to the extended position of the controllers if a different position of the controllers was desirable to the user or the position of the controller was an additional input to the simulation). The rotational degree of freedom can also accommodate differences in ergonomics or preferred posture better than if a single rotary angle were chosen. In addition, rotary stops may be added to the peg-in-hole mate-point to provide the user a sense of “range” of input for scaling their input actions to the controlled System. These motion stops can also provide points for the user to brace against to make the rotary mate-point feel more rigid and sturdy.

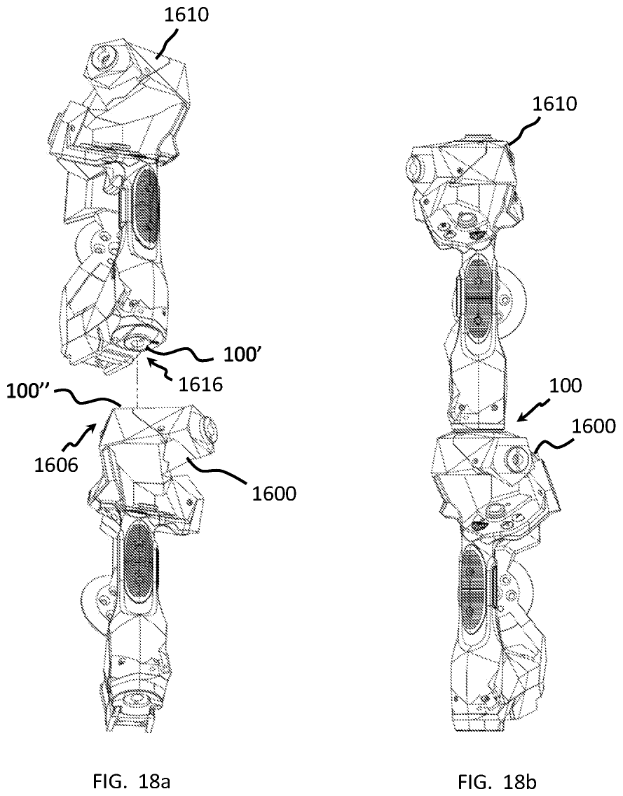

FIGS. 18a-18b depict a left controller 1600 and a right controller 1610. The left controller 1600 comprises a mate-point 100′ in the form of a left top mate-point 1606. Similarly, the right controller 1610 comprises a mate-point 100″ in the form of a right bottom mate-point 1616. One will appreciate, in view of the present disclosure, that mate-point 100′ and mate-point 100″ may comprise any mutually compatible mate-point 100 disclosed herein. As such, the description of the left top mate-point 1606 and the right bottom mate-point 1616 is provided for the sake of example and explanation regarding the relative placement of mate-points 100′ and 100″ and is not meant to necessarily indicate a particular type of mate-point 100 must be used.

FIGS. 18a and 18b show two controllers mated in the top-to-bottom (e.g., like a 2-handed sword) mate-point configuration using a peg-in-hole mate-point interface, as shown in FIGS. 2a-2b, 9a-9e, and 10a-10d. This mated controller configuration may be useful for interaction and input for a sword, light saber, pole arm, shovel, staff, spear, etc. The controllers are mated by bringing together the mate-point on the top of one controller with the mate-point on the bottom of a second controller along the dashed centerline as shown in FIG. 18a. FIGS. 18a and 18b show the controllers with the left controller on top of the right controller, where FIG. 18b shows the controllers with their respective mate-points mated. The controllers could also be mated with the right controller on top of the left controller. Utilizing a circular peg-in-hole mate-point allows for an additional rotational degree of input for this “2-handed sword” configuration. For example, if a game were to have a lightsaber, the rotational degree of freedom about the peg axis could be used to turn on the lightsaber or adjust its power. The rotational degree of freedom also accommodates the natural relative rotation between the user's hands as they move through their arm's workspace (e.g., from a resting position of the mated controllers against their body to the extended position of the controllers when the user is extending to strike or defend against an opponent). The rotation degree of freedom can also accommodate differences in human size and other human ergonomics better than if a single rotary angle were chosen. In addition, rotary stops may be added to the peg-in-hole mate-point to provide the user a sense of “range” of input for scaling their input actions to the controlled System. These motion stops can also provide points for the user to brace against to make the rotary mate-point feel more rigid and sturdy.

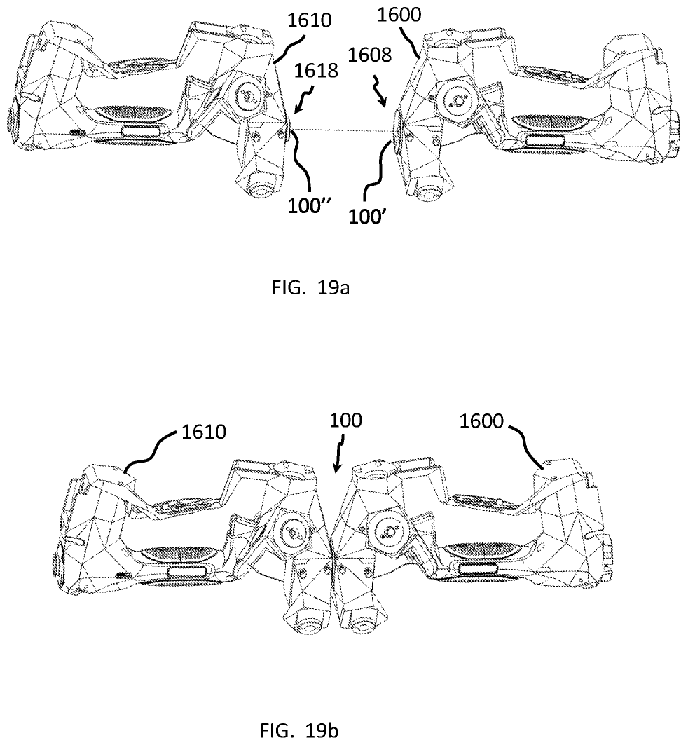

FIGS. 19a-19b depict a left controller 1600 and a right controller 1610. The left controller 1600 comprises a mate-point 100′ in the form of a left top mate-point 1608. Similarly, the right controller 1610 comprises a mate-point 100″ in the form of a left top point 1618. One will appreciate, in view of the present disclosure, that mate-point 100′ and mate-point 100″ may comprise any mutually compatible mate-point 100 disclosed herein. As such, the description of the left top mate-point 1608 and the right top mate-point 1618 is provided for the sake of example and explanation regarding the relative placement of mate-points 100′ and 100″ and is not meant to necessarily indicate a particular type of mate-point 100 must be used.

FIGS. 19a and 19b show two controllers mated in the top-to-top (handlebar) mate-point configuration using a peg-in-hole mate-point interface, as shown in FIGS. 2a-2b, 9a-9e, and 10a-10d. This mated controller configuration may be useful for interaction and input for vehicle handlebar, staff, exercise equipment, spear, etc. The controllers are mated by bringing together the mate-point on the top of one controller with the mate-point on the top of a second controller along the dashed centerline, as shown in FIG. 19a, shows the controllers with their respective mate-points mated. Utilizing a circular peg-in-hole mate-point allows for an additional rotational degree of input for this “handlebar” configuration. For example, if a game were to have a motorcycle throttle, the rotational degree of freedom about the peg axis could be used to increase or decrease the speed of the motorcycle. The rotational degree of freedom also accommodates the natural relative rotation between the user's hands as they move through their arm's workspace (e.g., from a resting position of the mated controllers against their body to the extended position of the controllers). The rotational degree of freedom can also accommodate differences in human size and other human ergonomics better than if a single rotary angle were chosen. In addition, rotary stops may be added to the peg-in-hole mate-point to provide the user a sense of “range” of input for scaling their input actions to the controlled System. These motion stops can also provide points for the user to brace against to make the rotary mate-point feel more rigid and sturdy.

The peg-in-hole mate-point designs (see FIGS. 2a-2b, 4a-4b, 9a-9e and 10a-10d) can support mixing and matching making connections at the top or bottom of controllers by placing male features on the controller in one hand and female mate-point features on the associated mate-points on the other hand (e.g., peg on right controllers, hole on left controllers). Greater care should be taken when using a mate-point design that does not allow a relative rotation (or translation), such as the mate-point designs shown in FIGS. 1a-1b, 7a-7d, 8a-8g, and 11a-15b, to ensure that the mated angle of the controllers is comfortable for users, which can be challenging when designing for a broad array of users (with associated size, age, and other differences between users).

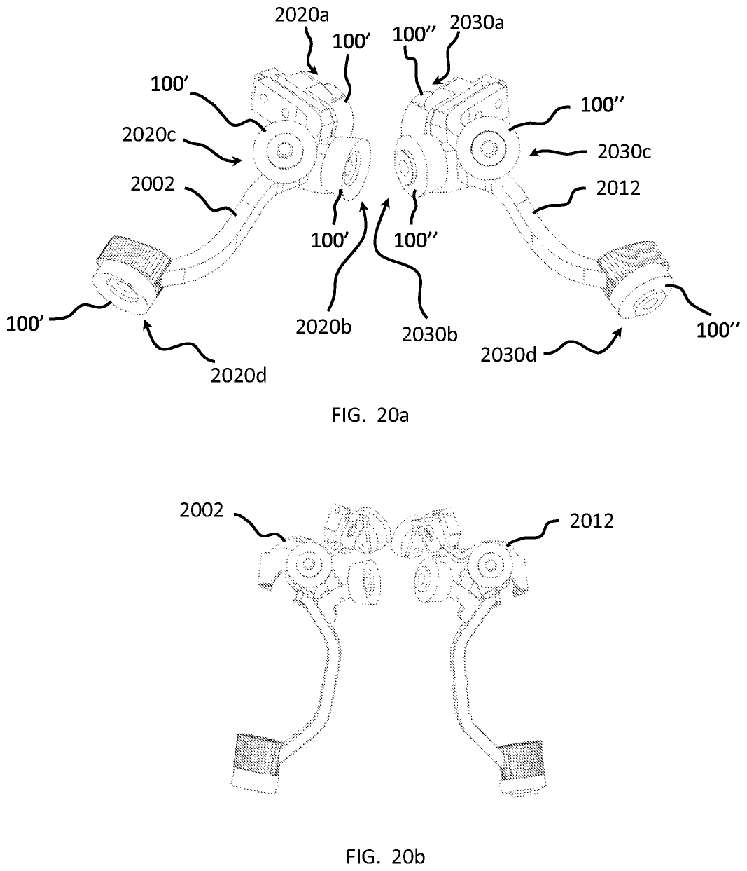

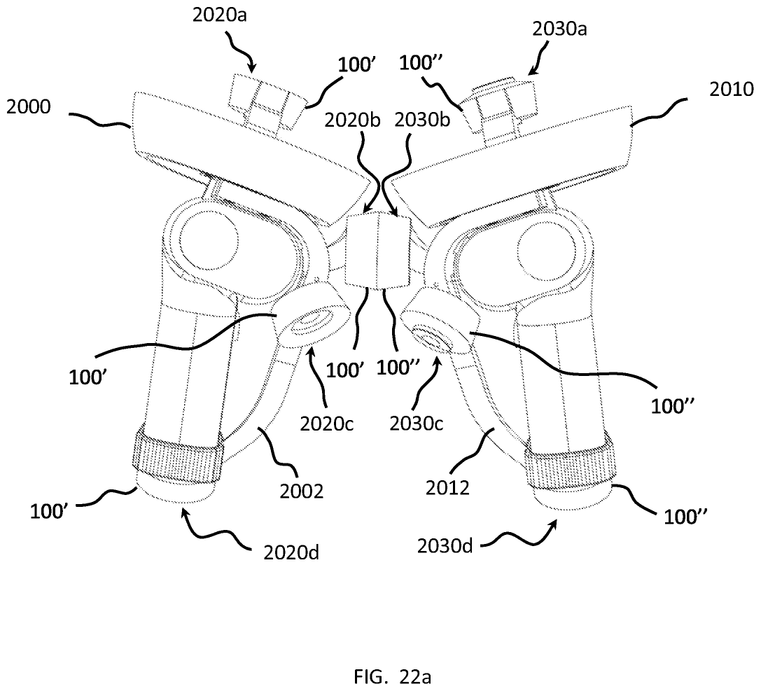

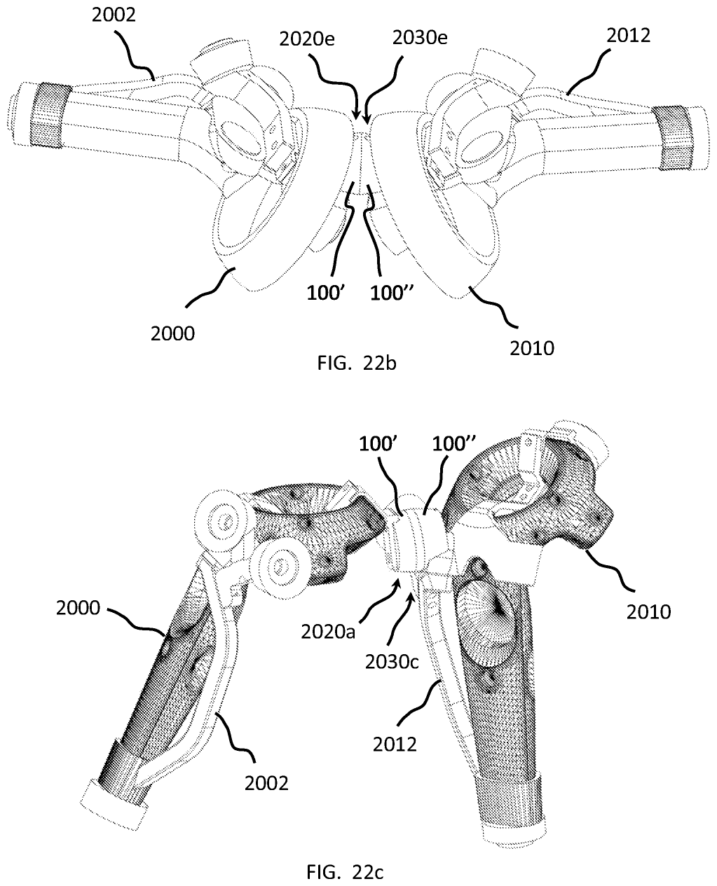

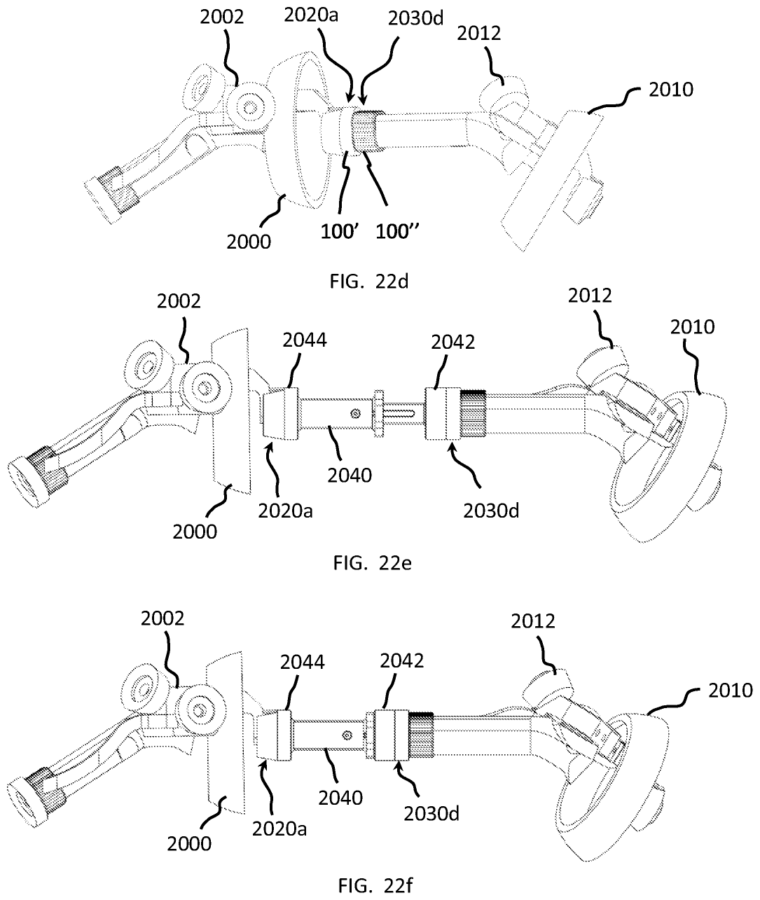

FIGS. 20a and 20b show an example of using a peg-in-hole mate-point as shown in FIGS. 2a-2b and 9a-9e. In contrast to FIGS. 16a-19b, FIGS. 20a and 20b show two examples of mate-point accessory brackets (2002 and 2012) that can be attached to commercially available game controllers (2000 and 2010, FIGS. 22a-22f). In at least one embodiment, once the accessory bracket (2002 and 2012) is attached to a game controller (2000 and 2010), the accessory bracket (2002 and 2012) is considered to be part of the controller housing. The accessories in FIGS. 20a (2002 and 2012) attach to WINDOWS Mixed Reality game controllers and add mate-points at the snout (2020a and 2030a), medial side (2020b and 2030b), back-medial (2020c and 2030c), and butt/bottom (2020d and 2030d) of the controller. The accessories in FIGS. 20b (2002 and 2012) attaches to an HTC VIVE virtual reality game controller and also adds mate-points 100 at the snout, medial side, back-medial, and butt/bottom of the controller.

Furthermore, these two accessories utilize male mate-points on the accessory for one controller (the right controller as shown in FIGS. 20a and 20b) and female mate-points on the other accessory (left controller as shown in FIGS. 20a and 20b). This allows any of the mate-points to be connected between controllers, several examples of which are shown in FIGS. 22a-22f.

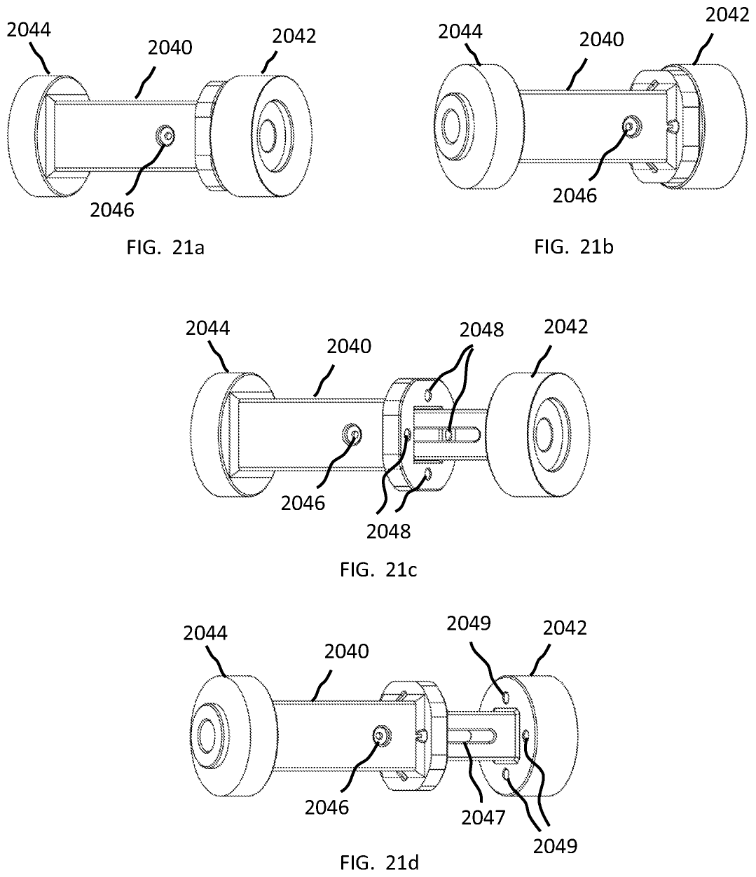

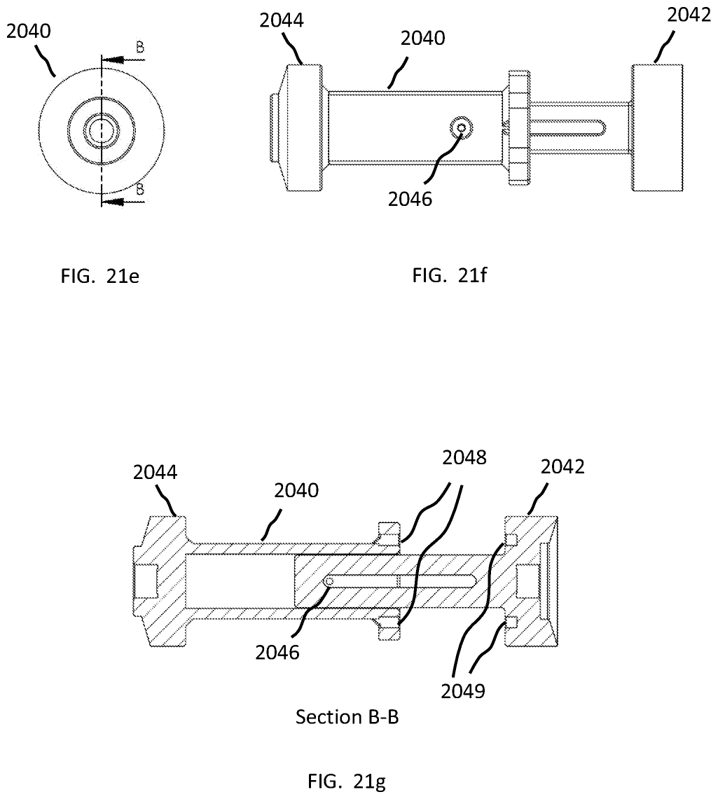

Game controllers (e.g., those shown in FIGS. 16a-19b) or accessories (e.g., FIGS. 20a-20b and 22a-22f) that incorporate mate-points can also be combined with other accessories, such as the prismatic slide 2040 shown in FIGS. 21a-21g. The accessory 2040 in FIGS. 21a-21g is an example of the concept expressed in FIGS. 3a-3e and 4a-4b, where the prismatic sliding degree of freedom is incorporated in an accessory that attaches to the game controller or game controller accessory bracket using magnetic peg-in-hole mate-points at its ends (2042 and 2044). In this example, the range of motion of the prismatic accessory is restricted using a screw or pin 2046 that is housed inside of a linear slot 2047, as shown in FIGS. 21c, 21d, 21f and 21g. As a means to keep the prismatic slide in the contracted position, weak magnets (2048 and 2049) can be incorporated on mating surfaces of the slide mechanism 2040. Keeping the prismatic slide in its contracted position can help prevent collisions between controllers when multiple controllers are un-mated and used independently by the user.

FIGS. 22a-22f depict mate-point game controller accessories used in combination with commercially available game controllers for Windows Mixed Reality (MR) and the HTC Vive virtual reality system. Similar accessories could be designed to interface with other game controllers. FIG. 22a shows mate-point accessories attached to Windows MR controllers, where the controllers are connected using mate-point interfaces (100) at the medial locations (2020b and 2030b) of each accessory 2002/2012 and controller 2000/2010. This pose resembles a bi-manual gamepad, steering wheel, or flight yoke hand pose. Additional mate-points (100′ and 100″) at the front (2020a and 2030a), medial/back side (2020c and 2030c), and bottom/butt of the controller (2020d and 2030d) are also shown, which can be used to form other controller poses.

FIG. 22b shows mate-point accessories attached to Windows MR controllers, where the controllers are connected using mate-point interfaces (100′ and 100″) at additional front locations (2020e and 2030e) of each accessory 2002/2012 and controller 2000/2010. This front-to-front pose resembles the handle bars of a bicycle or motor cycle, or a fighting staff. The rotational degree of freedom that remains in this pose when using peg and hole mate-points maps well to a motor cycle throttle interface and thus also provides an intuitive user input into a game or virtual reality simulation.

FIG. 22c shows mate-point accessories attached to HTC Vive game controllers, where the controllers are connected using mate-point interfaces (100′ and 100″) at the front location 2020a and medial/rear location 2030c of the left- 2000/2002 and right-handed 2010/2012 accessories/controllers. This pose resembles the hand pose when holding a machine gun. The rotational degree of freedom that remains in this pose when using peg and hole mate-points maps well to a reloading hand motion similar to the rotary motion of a gun bolt on a bolt-action rifle and thus also provides an intuitive user input into a game or virtual reality simulation.

FIG. 22d shows mate-point accessories attached to Windows MR game controllers, where the controllers are connected using mate-point interfaces (100′ and 100″) at the front location 2020a and bottom/butt location 2030c of the left- 2000/2002 and right-handed 2010/2012 accessories/controllers. This pose resembles the hand pose when holding a shotgun. In this pose, a prismatic sliding accessory (2040) could be added between the controller/accessory mate-points to provide a physical interface that resembles the motion of reloading a pump shotgun as shown in FIGS. 22e and 22f As shown, this sliding accessory 2040 utilizes the same magnetic peg-in-hole interface as the controller accessories (2000 and 2010) This sliding degree of freedom provides an intuitive user input into a game or virtual reality simulation.

FIGS. 1a-15b depict only typical mate-point designs of the invention and are not therefore to be considered to be limiting of its scope. FIGS. 16a-22f depict only typical mating configurations of the invention and are not therefore to be considered to be limiting of its scope.

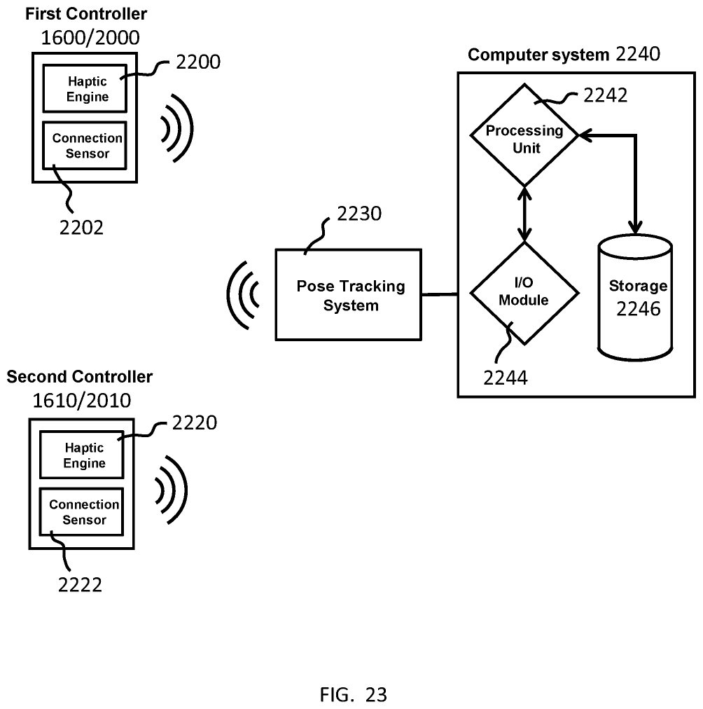

FIG. 23 illustrates an embodiment of a computer system 2240 for joining two separate controllers. For example, FIG. 23 illustrates a computer system that includes one or more processors and one or more computer-readable media having stored thereon executable instructions that when executed by the one or more processors configure the computer system to perform various actions. For instance, in at least one embodiment, the computer system is configured to identify, with a sensor group, a first pose of a first controller 2000 (also shown as 1600 in FIGS. 16a-19b) relative to a reference frame. The computer system 2240 is similarly configured to identify, with the sensor group, a second pose of a second controller 2010 (also shown as 1610 in FIGS. 16a-19b) relative to the reference frame.

In various embodiments, the sensor group may take different forms. For example, the sensor group may comprise a pose tracking system 2230 that is external to the first controller 2000 and the second controller 2010. The pose tracking system 2230 may also be internal to the first controller and second controller. The pose tracking system 2230 may also have components to it that are internal and external to the first controller 2000 and second controller 2010. The pose tracking system 2230 may also track the accessories and environment mate-points used with this system. The position and orientation of these accessories and environment mate-points may also be fixed or anchored in a known location, such that actively tracking their position and orientation is not necessary to recognize when a controller is in a mating configuration with the accessory or environment mate-point. The device position and orientation tracking system can include optical or image tracking equipment (e.g., cameras), depth sensors, LIDAR sensors, or any other conventional system used for tracking the pose of a user and/or user controllers. In additional or alternative embodiments, the sensor group may comprise a first set of sensors integrated within the first controller and a second set of sensors integrated within the second controller. The first set of sensors and the second set of sensors may both comprise IMUs embedded within the respective controllers. Each IMU may comprise various motion detecting sensors. Additionally, the first set of sensors and the second set of sensors may comprise GPS, optical sensors, sonars, magnetometers, and other similar intra-device sensors that are useable for tracking relative position and movement of a controller.

In at least one embodiment, an I/O module 2244 within the computer system receives the sensor data from the sensor group and processes it with a processing unit 2242. The sensor data may be received through wired communication, wireless communication, or through direct observation by the computer system. Further, in at least one embodiment, the computer system 2240 is at least partially integrated within both the first controller 2000 and the second controller 2010. In such an embodiment, processing units within the first controller and the second controller perform at least some of the processing described herein.

Once the sensor data is received, the computer system 2240 determines that the first pose and the second pose map to a first pose profile selected from a set of pose profiles that are within storage 2246. Each profile within the set of profiles maps to a particular configuration of mated controllers. For example, the first pose of the first controller may indicate that it is being held vertically aligned with a longitude plane of the user. The second pose of the second controller may indicate that it is also being vertically aligned with a longitude plane of the user directly, but above the first controller. Based upon this received sensor data from the sensor group, the computer system maps the first pose and the second pose to a pose profile that indicates that user is treating the two separate controllers as if they were a single controller mated together in a vertically aligned fashion (e.g., like a bow staff or two-handed sword). Examples of other possible pose profiles are provided herein and include poses such as a machine gun pose and a handle bar pose.

Once the first pose profile is identified, the computer system activates the first pose profile. The first pose profile comprises an input configuration file that is unique to the particular configuration of mated controller. For example, the IMU data from each controller will be interpreted differently when the two controllers are treated as being joined then when the two controllers are separate. Additionally or alternatively, in at least one embodiment, the first pose profile also comprises a haptic feedback configuration file (as shown in FIG. 23) that is unique to the particular configuration of mated controllers. As explained in more detail above, different controller matings invoke different haptic responses from haptic engines 2200, 2220 within the respective controllers 2000, 2010. Joining two controllers together in a bow staff, for example, will require different haptic responses in a fighting game than having the two controllers function as two separate clubs. In various embodiments, however, a controller does not comprise a haptic engine, and as such, does not receive a haptic feedback configuration file. Also in various embodiments, a controller need not comprise an IMU (as shown in FIG. 23). As such the system obtains its position tracking data by another means, as outlined above.

Accordingly, embodiments disclosed herein are capable of using sensor data about the position of a single controller or about two controllers (e.g., handheld controllers) to determine if the controllers are being held in relative poses that indicate the use of joining (or connecting or mating) the two controllers. As explained above, in at least one embodiment, the controllers are physically mated together using a connector. However, in at least one embodiment, the physical connection is not required for the computer system to determine that the user is treating the two controllers as if they are mated. For example, the computer system can determine that the pose of each controller relative to the user is such that the user is holding the controllers in accordance with a particular pose profile. The computer system can then activate the corresponding pose profile. Such a system allows a user to easily transform two separate controllers into a single device within a teleoperation environment, virtual reality (VR) environment, augmented reality (AR) environment, toy environment, gaming environment, or other environment.

More generally, a connection sensor 2202, 2222 can be integrated into the device housing, wherein the connection sensor could include at least one of an inertial measurement unit (IMU), a contact switch, electrical serial communication, electrical parallel communication, a magnetic sensor, a capacitive sensor, an inductive sensor, an optical sensor, or an RFID tag. Placing a connection sensor 2202, 2222 at each mate-point can be used to sense which of a plurality of connection locations on a controller is connected to another controller or mate-point in the environment. This approach can be advantageous as it doesn't require explicit position tracking of the device to determine if the devices are mated. Connection sensors 2202, 2222 at the mate-points, near the mate-points, or elsewhere in/on the device can also be used to measure relative position and orientation between mated controllers or a controller and an environment mate-point.

The terms “approximately,” “about,” and “substantially” as used herein represent an amount close to the stated amount that still performs a desired function or achieves a desired result. For example, the terms “approximately,” “about,” and “substantially” may refer to an amount that is within less than 10% of, within less than 5% of, within less than 1% of, within less than 0.1% of, and within less than 0.01% of a stated amount.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

What is claimed is:

1. A controller device system with at least one mate-point, the device comprising:
a mate-point positioned on a housing of a controller device;
and a set of pose profiles, wherein:
the set of pose profiles comprise unique pose profiles for different mate-point configurations.

2. The device in claim 1, wherein a connection sensor is integrated into the housing.

3. The device in claim 2, wherein the connection sensor includes at least one of an inertial measurement unit (IMU), a contact switch, electrical serial communication, electrical parallel communication, a magnetic sensor, a capacitive sensor, an inductive sensor, an optical sensor, or an RFID tag.

4. The device of claim 1, wherein the controller device system is trackable by a device position and orientation tracking system.

5. The device in claim 4, wherein at least a portion of pose profiles within the set of profiles are associated with unique algorithms for interpreting measurements from the device position and orientation tracking system.

6. The device of claim 1, wherein the mate-point provides an additional degree of freedom for user-initiated movement of the controller device.

7. The device of claim 6, wherein the mate-point allows at least one rotary degree of freedom after mating.

8. The device of claim 6, wherein the additional degree of freedom comprises a user input in the controller device system.

9. The device of claim 1, wherein the mate-point allows electrical power or signals to be transmitted across it after mating.

10. The device of claim 1, wherein the mate-point is embedded within an accessory attached to a controller.

11. A computer system for dynamically joining two separate controllers, comprising:
one or more processors; and
one or more computer-readable media having stored thereon executable instructions that when executed by the one or more processors configure the computer system to perform at least the following:
identify with a sensor group a first pose of a first controller relative to a reference frame;
identify with the sensor group a second pose of a second controller relative to the reference frame;
determine that the first pose and the second pose map to a first pose profile selected from a set of pose profiles, wherein the first pose profile is associated with a particular configuration of mated controllers; and
activate the first pose profile, wherein the first pose profile comprises:
an input configuration file that is unique to the particular configuration of mated controller.

12. The computer system of claim 11, wherein the first controller comprises a first handheld controller and the second controller comprises a second handheld controller.

13. The computer system of claim 11, wherein the sensor group comprises a pose tracking system that is external to the first controller and the second controller.

14. The computer system of claim 11, wherein the sensor group includes at least one of an inertial measurement unit (IMU), a contact switch, electrical serial communication, electrical parallel communication, a magnetic sensor, a capacitive sensor, an inductive sensor, an optical sensor, or an RFID tag.

15. The computer system of claim 14, wherein the first pose profile also comprises a haptic feedback configuration file that is unique to the particular configuration of mated controllers.
